(19) United States
(12) Patent Application Publication
(10) Pub. No.: US 2013/0080587 A1
(43) Pub. Date: Mar. 28, 2013

(54) DISPLAY APPARATUS, OPERATION APPARATUS, APPARATUS COORDINATION CONTROL SYSTEM, DISPLAY METHOD, OPERATION METHOD, AND APPARATUS COORDINATION CONTROL METHOD

(71) Applicant: Hideaki Yajima, Tokyo (JP)

(72) Inventor: Hideaki Yajima, Tokyo (JP)

(21) Appl. No.: 13/702,329

(22) PCT Filed: Apr. 12, 2012
(86) PCT No.: PCT/JP2012/002546

§ 371 Date: Dec. 6, 2012

(30) Foreign Application Priority Data
May 13, 2011 (JP) 2011-108726

(51) Int. Cl. H04L 29/08

(52) U.S. Cl. CPC H04L 67/00
USPC 709/217

(57) ABSTRACT

A display apparatus is connected to a first operation apparatus and a second operation apparatus via a communication network and displays display data on a screen according to a request from the first operation apparatus, the first operation apparatus and the second operation apparatus operating the display data displayed on the screen. The display apparatus includes: a display unit that receives the display data transmitted from the first operation apparatus and displays the received display data on the screen; and a proxy obtainment unit that obtains, from the first operation apparatus, an identifier that identifies operational information used for operating the display data displayed by the display unit and allows the second operation apparatus to obtain the operational information specified by the identifier when requested by the second operation apparatus to obtain the operational information.

### TECHNICAL FIELD

The present invention relates to apparatuses and systems used in order for the apparatuses to operate in coordination with each other. In particular, the present invention relates to an apparatus coordination control system, an apparatus coordination control method, a display apparatus, an operation apparatus, and an operation method with which data displayed on an apparatus, such as the display apparatus, is operated from a different apparatus, such as the operation apparatus, via a communication network.

### BACKGROUND ART

With a conventionally-proposed apparatus coordination control system, a target apparatus to be operated is selected from among apparatuses connected to a communication network and an operation request is notified to each selected apparatus to implement apparatus coordination (see Patent Literature 1, for example).

### CITATION LIST

### Patent Literature

### PTL 1

Patent Publication U.S. Pat. No. 4,596,572

### SUMMARY OF INVENTION

### Technical Problem

With the conventional configuration, however, a target operation apparatus from which display data and an operational user interface (UI) are to be obtained needs to be selected from among operation apparatuses, and a display apparatus that displays the display data also needs to be selected. On account of this, even in the case where the display data is displayed on the display apparatus by operating an operation apparatus A and then the data displayed on the display apparatus is to be operated from a different operation apparatus B, these two apparatuses need to be selected again as coordination targets.

The present invention is conceived to solve the stated conventional problem, and has an object to provide a display apparatus, an operation apparatus, an apparatus coordination control system, a display method, an operation method, and an apparatus coordination control method capable of operating display data displayed on the display apparatus without knowing which apparatus holds the display data and operational information including an operational UI.

### Solution to Problem

In order to solve the stated conventional problem, the display apparatus in an aspect according to the present invention is a display apparatus that is connected to a first operation apparatus and a second operation apparatus via a communication network and displays display data on a screen according to a request from the first operation apparatus, each of the first operation apparatus and the second operation apparatus operating the display data displayed on the screen and the display apparatus including: a display unit which receives the display data transmitted from the first operation apparatus and displays the received display data on the screen; and a proxy obtainment unit which obtains, from the first operation apparatus, an identifier that identifies operational information used for operating the display data displayed by the display unit, and allows the second operation apparatus to obtain the operational information specified by the identifier when requested by the second operation apparatus to obtain the operational information.

It should be noted that a general or specific embodiment in an aspect may be implemented by a system, a method, an integrated circuit, a computer program, or a recording medium, or by any combination of an apparatus, a system, a method, an integrated circuit, a computer program, and a recording medium.

### ADVANTAGEOUS EFFECTS OF INVENTION

The display apparatus according to the present invention allows the operation apparatus to obtain the operational information used for operating the current display data and also allows the user to operate this display data even when the user does not know which apparatus holds the display data and the operational information including the operational UI.

### BRIEF DESCRIPTION OF DRAWINGS

FIG. 1 is a diagram showing a configuration of an apparatus coordination control system in Embodiment 1 according to the present invention.

FIG. 2 is a diagram showing a configuration of a display apparatus in Embodiment 1 according to the present invention.

FIG. 3A is a diagram showing a configuration of a first operation apparatus in Embodiment 1 according to the present invention.

FIG. 3B is a diagram showing a configuration of a second operation apparatus in Embodiment 1 according to the present invention.

FIG. 4 is a diagram showing details of data held by a data holding unit in Embodiment 1 according to the present invention.

FIG. 5 is a flowchart showing a process performed when the first operation apparatus causes the display apparatus to display the display data, in Embodiment 1 according to the present invention.

FIG. 6 is a flowchart showing a process performed by the second operation apparatus to display an operational UI, in Embodiment 1 according to the present invention.

FIG. 7 is a flowchart showing a process performed by the first operation apparatus to terminate display of the display data, in Embodiment 1 according to the present invention.

FIG. 8 is a sequence diagram showing processes performed by the display apparatus, the first operation apparatus, and the second operation apparatus, in Embodiment 1 according to the present invention.

FIG. 9 is a diagram explaining processes performed by the display apparatus, the first operation apparatus, and the second operation apparatus, in Embodiment 1 according to the present invention.

FIG. 10A is a diagram showing a minimum configuration of the first operation apparatus in Embodiment 1 according to the present invention.

FIG. 10B is a diagram showing a minimum configuration of the second operation apparatus in Embodiment 1 according to the present invention.

FIG. 11 is a sequence diagram showing processes performed by a display apparatus, a first operation apparatus, and a second operation apparatus, in Modification of Embodiment 1 according to the present invention.

FIG. 12 is a diagram showing a configuration of an apparatus coordination control system in Embodiment 2 according to the present invention.

FIG. 13A is a diagram showing a configuration of a first display apparatus in Embodiment 2 according to the present invention.

FIG. 13B is a diagram showing a configuration of a second display apparatus in Embodiment 2 according to the present invention.

FIG. 14A is a diagram showing a configuration of a first operation apparatus in Embodiment 2 according to the present invention.

FIG. 14B is a diagram showing a configuration of a second operation apparatus in Embodiment 2 according to the present invention.

FIG. 15 is a sequence diagram showing processes performed by the first display apparatus, the second display apparatus, the first operation apparatus, and the second operation apparatus, in Embodiment 1 according to the present invention.

FIG. 16 is a diagram explaining processes performed by the first display apparatus, the second display apparatus, the first operation apparatus, and the second operation apparatus, in Embodiment 1 according to the present invention.

FIG. 17 is a diagram explaining a configuration of a conventional apparatus coordination control system.

FIG. 18 is a diagram explaining a configuration of a conventional display apparatus.

FIG. 19 is a diagram explaining a configuration of a conventional target operation apparatus.

FIG. 20 is a diagram explaining a configuration conventional operation apparatus.

### DESCRIPTION OF EMBODIMENTS

### Knowledge Forming Basis of Present Invention

The inventor of the present invention has found out that the apparatus coordination system described above in “Background Art” has a problem as follows.

FIG. 17 is a diagram explaining the conventional apparatus coordination control system described in Patent Literature 1 mentioned above. To be more specific, this diagram shows a configuration of an apparatus coordination control system to present an example of the technology related to the conventional apparatus coordination control system.

In this diagram, a display apparatus 1000 is a TV, a display, or the like that provides display on a screen, and is connected to a target operation apparatus 1100 and an operation apparatus 1200 via a communication network such as a local area network (LAN). Examples of the target operation apparatus 1100 include a digital video recorder, a digital camera, a smartphone, a tablet computer, and a music player that hold display data such as video and photographs. In response to a request from the operation apparatus 1200, the target operation apparatus 1100 causes the display apparatus 1000 to display the display data. The operation apparatus 1200 is a smartphone, a tablet computer, or the like that is operated directly by the user.

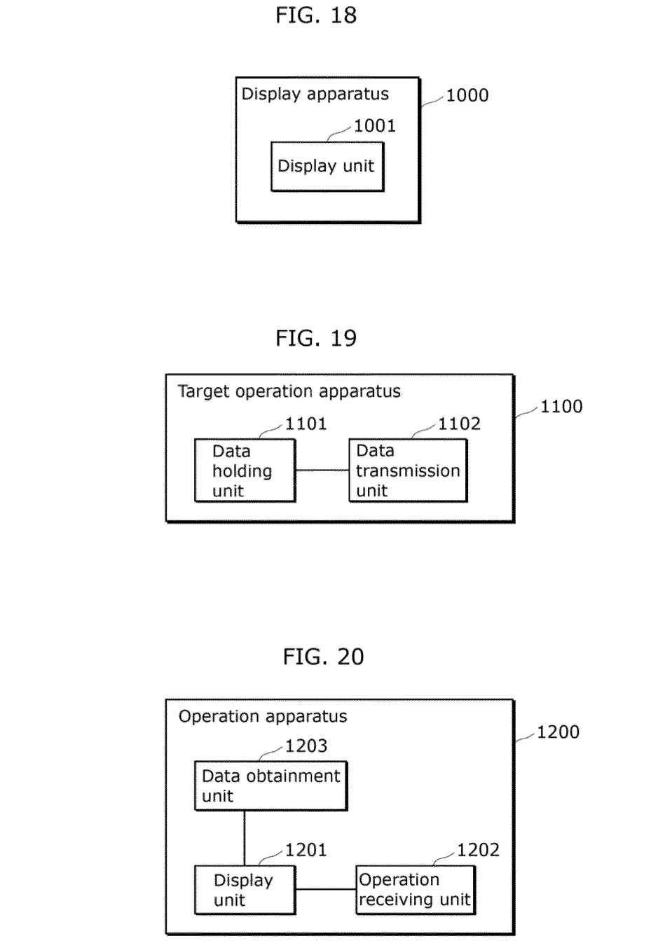

FIG. 18 is a diagram explaining a configuration of a conventional display apparatus. To be more specific, this diagram shows a configuration of the display apparatus 1000 to present an example of the technology related to the conventional display apparatus.

In this diagram, the display apparatus 1000 includes a display unit 1001. In response to a request from the operation apparatus 1200, the display unit 1001 displays, on a display device such as a liquid crystal display (LCD), display data transmitted from a data transmission unit 1102 of the target operation apparatus 1100.

FIG. 19 is a diagram explaining a configuration of a conventional target operation apparatus. To be more specific, this diagram shows a configuration of the target operation apparatus 1100 to present an example of the technology related to the conventional target operation apparatus.

In this diagram, the target operation apparatus 1100 includes a data holding unit 1101 and the data transmission unit 1102. The data holding unit 1101 includes a memory device, such as a hard disk drive (HDD) or a flash memory, and holds display data and an operational UI for operating the display data. The data transmission unit 1102 receives a request from the operation apparatus 1200, and transmits the display data held by the data holding unit 1101 to the display unit 1001 of the display apparatus 1000 to cause the display apparatus 1000 to display the display data.

FIG. 20 is a diagram explaining a configuration of a conventional operation apparatus. To be more specific, this diagram shows a configuration of the operation apparatus 1200 to present an example of the technology related to the conventional operation apparatus.

In this diagram, the operation apparatus 1200 includes a display unit 1201, an operation receiving unit 1202, and a data obtainment unit 1203. As with the display unit 1001, the display unit 1201 displays display data on a display device such as an LCD. Moreover, the display unit 1201 displays the operational UI held by the data holding unit 1101, and changes the details displayed by the display unit 111 according to a user operation notified by the operation receiving unit 1202. The operation receiving unit 1202 is a processing unit, such as a touch panel or keys, that receives a user operation, and notifies the display unit 1201 of a result of the user operation. In response to a request from the display unit 1201, the data obtainment unit 1203 obtains the operational UI held by the data hold unit 1101 and transmits the operational UI to the display unit 1201.

With the above configuration, the user causes the display unit 1001 of the display apparatus 1000 to display the display data held by the data holding unit 1101 of the target operation apparatus 1100 and operates this display data from the operational UI displayed by the operation apparatus 1200. In this case, the display unit 1201 of the operation apparatus 1200 firstly displays a list of apparatuses connected to the communication network. From this list, the target operation apparatus 1100 holding the display data is selected via the operation receiving unit 1202. Then, from the data holding unit 1101 via the data obtainment unit 1203, the display unit 1201 obtains the operational UI used for operating the display data and displays the obtained operational UI.

Next, the user selects the desired display data to be displayed on the display apparatus 1000 from among the display data held by the data holding unit 1101, using the operational UI obtained from the target operation apparatus 1100. Then, from the list of the apparatuses connected to the communication network that is displayed by the display unit 1201, the user selects the display apparatus 1000 on which the user wishes the display data to be displayed via the operation receiving unit 1202 of the operation apparatus 1200. Thus, the display unit 1201 requests the data transmission unit 1102 to transmit the selected display data to the display apparatus 1000. In response to the request, the data transmission unit 1102 transmits the selected display data to the display unit 1101 of the display apparatus 1000. Finally, the user operates the display data displayed by the display unit 1001 of the display apparatus 1000, using the operational UI obtained from the target operation apparatus 1100.

With the above configuration, however, the target operation apparatus from which the display data and the operational UI are to be obtained needs to be selected from among the operation apparatuses, and the display apparatus that displays the display data also needs to be selected. On account of this, even in the case where the display data is displayed on the display apparatus by operating an operation apparatus A and then the data displayed on the display apparatus is to be operated from a different operation apparatus B, these two apparatuses need to be selected again as coordination targets.

In particular, suppose that a user B different from a user A operating the operation apparatus A watches the display data displayed on the display apparatus and tries to operate the display data displayed on the display apparatus from the operation apparatus B. In this case, the user B can only obtain information about the display apparatus and the display data displayed thereon. For this reason, the user B cannot identify, from among the apparatuses connected to the communication network, the target operation apparatus from which the currently displayed data and the operational UI are to be obtained, and thus cannot perform any operation.

The present invention is conceived to solve the stated problem, and has an object to provide a display apparatus, an operation apparatus, an apparatus coordination control system, a display method, an operation method, and an apparatus coordination control method capable of operating display data displayed on the display apparatus without knowing which apparatus holds the display data and operational information including an operational UI.

In order to achieve the aforementioned object, the display apparatus in an aspect according to the present invention is a display apparatus that is connected to a first operation apparatus and a second operation apparatus via a communication network and displays display data on a screen according to a request from the first operation apparatus, each of the first operation apparatus and the second operation apparatus operating the display data displayed on the screen and the display apparatus including: a display unit which receives the display data transmitted from the first operation apparatus and displays the received display data on the screen; and a proxy obtainment unit which obtains, from the first operation apparatus, an identifier that identifies operational information used for operating the display data displayed by the display unit, and allows the second operation apparatus to obtain the operational information specified by the identifier when requested by the second operation apparatus to obtain the operational information.

With this, the proxy obtainment unit obtains, from the first operation apparatus, the identifier that identifies the operational information and, when receiving a request from the second operation apparatus to obtain the operational information, allows the second operation apparatus to obtain the operational information specified by the identifier. Thus, the user may simply select the display apparatus that displays the display data which the user wishes to operate, using the second operation apparatus. As a result, the second operation apparatus obtains the operational information including the corresponding operational UI, and the user thus can operate the display data using this operational UI. More specifically, the user can operate the desired display data through a simple operation of selecting the display apparatus, without regard to locations where the display data displayed by the display apparatus and the operational UI for operating this display data are stored. In this way, since the operation apparatus operated by the user obtains the operational information, the user can operate the display data without knowing which apparatus holds the display data and the operational information.

Moreover, the operational UI corresponding to the display data displayed by the display apparatus is obtained via the proxy obtainment unit of the display apparatus. This can prevent an operational UI corresponding display data other than the display data shown to a different user for shared use via the display apparatus, from being obtained against intentions of the user.

Furthermore, for example, the proxy obtainment unit may (i) obtain, as the identifier, storage location information regarding a storage location of the operational information held by the first operation apparatus, (ii) obtain the operational information from the storage location indicated by the storage location information, when requested by the second operation apparatus to obtain the operational information, and (iii) allow the second operation apparatus to obtain the operational information by transmitting the obtained operational information to the second operation apparatus.

With this, the proxy obtainment unit obtains, as the identifier that identifies the operational information, the storage location information regarding the storage location of the operational information held by the first operation apparatus. Then, the proxy obtainment unit obtains the operational information from the storage location of the operational information indicated by the storage location information and transmits the operational information to the second operation apparatus. To be more specific, the proxy obtainment unit allows the second operation apparatus to obtain the operational information by directly transmitting the operational information to the second operation apparatus. Thus, the operation apparatus operated by the user can obtain the operational information. Therefore, the user can operate the display data without knowing which apparatus holds the display data and the operational information.

Moreover, for example, the proxy obtainment unit may (i) obtain, as the identifier, storage location information regarding a storage location of the operational information held by the first operation apparatus, and (ii) allow the second operation apparatus to obtain the operational information by transmitting the storage location information to the second operation apparatus, when requested by the second operation apparatus to obtain the operational information.

With this, the proxy obtainment unit obtains, as the identifier that identifies the operational information, the storage location information regarding the storage location of the operational information held by the first operation apparatus. Then, the proxy obtainment unit transmits the operational information to the second operation apparatus. To be more specific, the proxy obtainment unit allows the second operation apparatus to obtain the operational information from the storage location information, by transmitting the operational information to the second operation apparatus. Thus, the operation apparatus operated by the user can obtain the operational information. Therefore, the user can operate the display data without knowing which apparatus holds the display data and the operational information.

Furthermore, for example, when receiving a request from the first operation apparatus to terminate display of the display data, the proxy obtainment unit may cause the second operation apparatus to delete the operational information obtained by the second operation apparatus.

With this, when receiving a request from the first operation apparatus to terminate display of the display data, the proxy obtainment unit causes the second operation apparatus to delete the held operational information. To be more specific, since the operational information is deleted after display of the display data is terminated, an operation via the operational UI can be prevented from being performed at timing that is against intentions of the user, such as when the operational UI is operated by a different user.

Moreover in order to achieve the aforementioned object, the operation apparatus in an aspect according to the present invention is an operation apparatus that is connected via a communication network to a display apparatus displaying display data on a screen and operates the display data displayed by the display apparatus, the operation apparatus including: a data holding unit which holds an identifier that identifies operational information used for operating the display data; a data transmission unit which transmits the identifier held by the data holding unit to the display apparatus and allows the display apparatus to obtain the display data and; and a data obtainment unit which obtains the identifier received by the display apparatus, according to an obtainment request made to the display apparatus to obtain the operational information by a different operation apparatus operating the display data, wherein, when the data obtainment unit obtains the identifier, the data transmission unit transmits the operational information specified by the identifier to allow the different operation apparatus to obtain the operational information.

With this, the data transmission unit transmits, to the display apparatus, the identifier that identifies the operational information held by the data holding unit. After this, when obtaining the identifier, the data transmission unit transmits the operational information specified by the identifier to allow a different operation apparatus to obtain the operational information. Thus, the user may simply select the display apparatus that displays the display data which the user wishes to operate, using the different operation apparatus. As a result, the different operation apparatus obtains the operational information including the corresponding operational UI, and the user thus can operate the display data using this operational UI. More specifically, the user can operate the desired display data through a simple operation of selecting the display apparatus, without regard to locations where the display data displayed by the display apparatus and the operational UI for operating this display data are stored. In this way, since the operation apparatus operated by the user obtains the operational information, the user can operate the display data without knowing which apparatus holds the display data and the operational information.

Furthermore, for example, the data holding unit may hold, as the identifier, storage location information regarding a storage location of the operational information, in association with the display data and the operational information, the data transmission unit may transmit, to the display apparatus, the display data and the storage location information both held by the data holding unit, the data obtainment unit may obtain, from the display apparatus, the storage location information received by the display apparatus, according to the obtainment request, and the data transmission unit may transmit, to the display apparatus, the operational information associated with the storage location information held by the data holding unit to allow the different operation apparatus to obtain the operational information via the display apparatus, when the data obtainment unit obtains the storage location information from the display apparatus.

With his, the data transmission unit transmits, to the display apparatus, the storage location information regarding the storage location of the operational information held by the data holding unit, as the identifier that identifies the operational information. After this, when the data obtainment unit obtains the storage location information from the display apparatus, the data transmission unit transmits the operational information corresponding to the storage location information to the display apparatus. To be more specific, when the data transmission unit transmits the operational information to the display apparatus and the display apparatus transmits the operational information to the different operation apparatus, the second operation apparatus can obtain the operational information. Thus, since the operation apparatus operated by the user obtains the operational information, the user can operate the display data without knowing which apparatus holds the display data and the operational information.

Moreover, for example, the data holding unit may hold, as the identifier, storage location information regarding a storage location of the operational information, in association with the display data and the operational information, the data transmission unit may transmit, to the display apparatus, the display data and the storage location information both held by the data holding unit, the data obtainment unit may obtain, from the different operation apparatus, the storage location information that the display apparatus has received and transmitted to the different operation apparatus, according to the obtainment request, and the data transmission unit may transmit, to the different operation apparatus, the operational information associated with the storage location information held by the data holding unit to allow the different operation apparatus to obtain the operational information, when the data obtainment unit obtains the storage location information from the different operation apparatus.

With this, the data transmission unit transmits, to the display apparatus, the storage location information regarding the storage location of the operational information held by the data holding unit, as the identifier that identifies the operational information. After this, when the data obtainment unit obtains the storage location information from the different operation apparatus, the data transmission unit transmits the operational information corresponding to the storage location information to the different operation apparatus. To be more specific, the data transmission unit allows the different operation apparatus to obtain the operational information by directly transmitting the operational information to the different operation apparatus. Thus, since the operation apparatus operated by the user obtains the operational information, the user can operate the display data without knowing which apparatus holds the display data and the operational information.

Furthermore, for example, the data obtainment unit may further receive a termination request to terminate display of the display data displayed by the display apparatus, and when the data obtainment unit receives the termination request, the data transmission unit may transmit the termination request to terminate display of the display data to the display apparatus and cause the different operation apparatus to delete the operational information obtained by the different operation apparatus.

With this, when the data obtainment unit receives the termination request to terminate display of the display data, the data transmission unit causes the different operation apparatus to delete the held operational information. To be more specific, since the operational information is deleted after display of the display data is terminated, an operation via the operational UI can be prevented from being performed at timing that is against intentions of the user, such as when the operational UI is operated by a different user.

Moreover, for example, when the data obtainment unit receives the termination request, the data transmission unit may further cause the display apparatus to delete the identifier held by the display apparatus.

With this, when the data obtainment unit receives the termination request to terminate display of the display data, the data transmission unit causes the display apparatus to delete the held operational information. More specifically, the storage location information held by the display apparatus is deleted after display of the display data is terminated. Therefore, even when a request is received from a different user to obtain the operational information, the operational UI is prevented from being obtained by this different user via the display apparatus. Moreover, an operation via the operational UI can be prevented from being performed at timing against intentions of the user.

Furthermore, for example, the data holding unit may hold, as the identifier, an identifier that identifies operational information where a predetermined operation is not permitted, and the data transmission unit may allow the different operation apparatus to obtain the operational information, specified by the identifier, where the predetermined operation is not permitted.

With this, the data transmission unit allows the different operation apparatus to obtain the operational information where the predetermined operation is not permitted. Thus, the user cannot perform the predetermined operation on the display data even by means of the different operation apparatus. By limiting changes to be made by the operation apparatus to the display data, a change to the display data against intentions of the user can be prevented from being made.

Moreover, in order to achieve the aforementioned object, the operation apparatus in an aspect according to the present invention is an operation apparatus that is connected to a different operation apparatus, a first display apparatus, and a second display apparatus via a communication network and operates display data displayed by the first display apparatus and the second display apparatus, the different operation apparatus causing the first display apparatus and the second display apparatus to display the display data and the operation apparatus including: a data obtainment unit which obtains (i) operational information used for operating the display data displayed by the first display apparatus or the second display apparatus, according to an obtainment request, and (ii) first display apparatus information indicating the first display apparatus and second display apparatus information indicating the second display apparatus from the different operation apparatus via the first display apparatus or the second display apparatus; a data holding unit which holds the obtained operational information; a coordinated-apparatus-information holding unit which holds the obtained first display apparatus information and the obtained second display apparatus information; and a data transmission unit which transmits, to the first display apparatus and the second display apparatus, data for changing, using the operational information held by the data holding unit, the display data displayed by the first display apparatus and the second display apparatus indicated respectively by the first display apparatus information and the second display apparatus information held by the coordinated'-apparatus-information holding unit.

With this, the data obtainment unit obtains the operational information and, based on the operational information, the data transmission unit transmits, to the first display apparatus and the second display apparatus, the data for changing the display data displayed by the first display apparatus and the second display apparatus indicated respectively by the first display apparatus information and the second display apparatus information held by the apparatus information holding unit. More specifically, since the data for changing the display data is transmitted to both the first display apparatus and the second display apparatus based on the operational information obtained by the operation apparatus, the user can change, in a single step, the display data displayed by the first display apparatus and the second display apparatus. In this way, the operation apparatus operated by the user can obtain the operational information regarding the plurality of display apparatuses. Hence, the user can easily operate the display data displayed by the display apparatuses without knowing which apparatus holds the display data and the operational information.

It should be noted that the present invention can be implemented not only as a display apparatus and an operation apparatus as described, but also as an apparatus coordination control system including the display apparatus and the operation apparatus. Moreover, the present invention can be implemented as: a display method, an operation method, or an apparatus coordination control method having, as steps, the characteristic processing units included in the display apparatus, the operation apparatus, or the apparatus coordination control system; and a computer program causing a computer to execute the characteristic steps included in the method. It should be obvious that the computer program can be distributed via a recording medium such as a Compact Disc-Read Only Memory (CD-ROM) or via a transmission medium such as the Internet. Moreover, the present invention may be implemented as a large scale integrated (LSI) circuit including some or all of the functions of the display apparatus or the operation apparatus. Furthermore, the present invention may be implemented by any combination of the stated apparatuses, system, methods, integrated circuit, computer program, and recording medium.

The following is a detailed description of Embodiments according to the present invention, with reference to the drawings. It should be noted that each of Embodiments below describes only a preferred specific example. Note that numerical values, shapes, materials, components, locations and connection states of the components, steps, a sequence of the steps, and so forth described in Embodiments below are only examples and are not intended to limit the present invention. Thus, among the components described in Embodiments below, the components that are not described in independent claims indicating top concepts according to the present invention are described as optional components.

### Embodiment 1

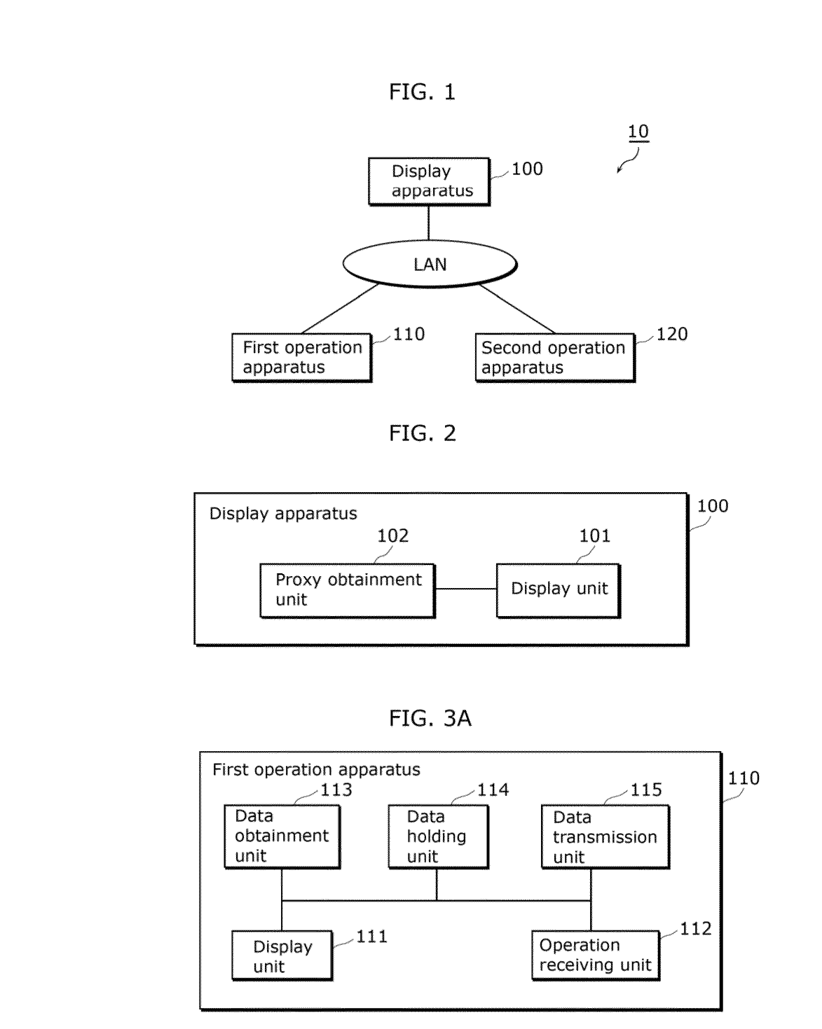

FIG. 1 is a diagram showing a configuration of an apparatus coordination control system 10 in Embodiment 1 according to the present invention.

As shown in this diagram, a display apparatus 100 is a TV, a display, or the like that provides display on a screen as with the display apparatus 1000. For example, the display apparatus 100 provides display on a display screen of a car navigation system installed in a car. Moreover, the display apparatus 100 is connected to a first operation apparatus 110 and a second operation apparatus 120 via a communication network, such as a local area network (LAN).

As with the operation apparatus 1200, each of the first operation apparatus 110 and the second operation apparatus 120 is a smartphone, a tablet computer, or the like that is operated directly by the user. For example, each of the first operation apparatus 110 and the second operation apparatus 120 operates a screen displayed on a display screen of a car navigation system.

To be more specific, the display apparatus 100 displays display data on the screen according to a request from the first operation apparatus 110 or the second operation apparatus 120. Thus, each of the first operation apparatus 110 and the second operation apparatus 120 operates the display data displayed by the display apparatus 100.

FIG. 2 is a diagram showing a configuration of the display apparatus 100 in Embodiment 1 according to the present invention.

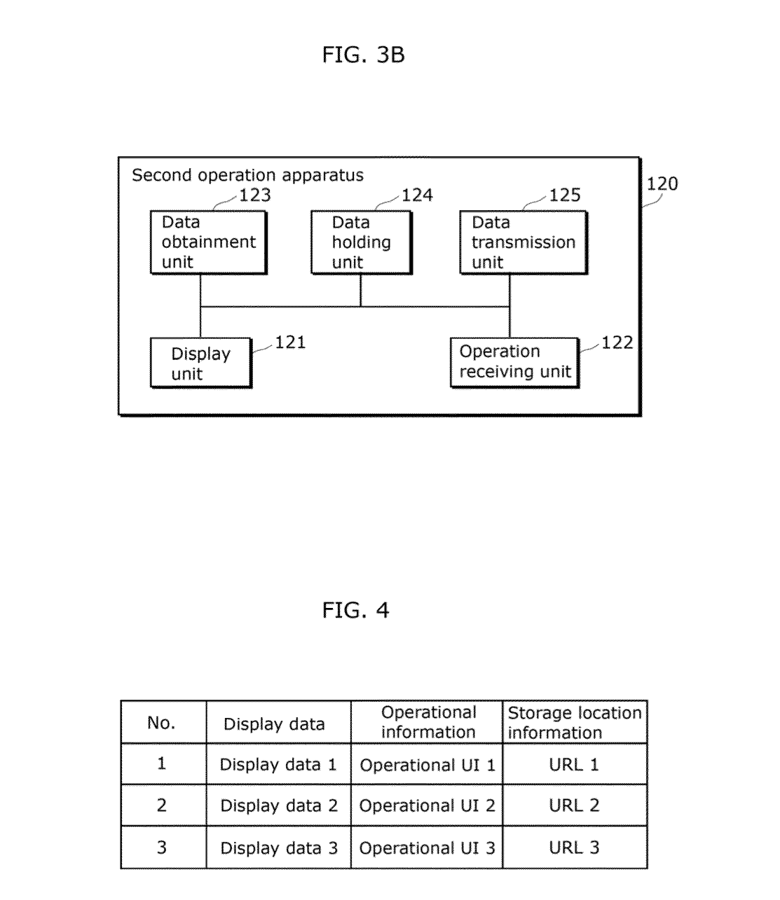

FIG. 3A is a diagram showing a configuration of the first operation apparatus 110 in Embodiment according to the present invention.

FIG. 3B is a diagram showing a configuration of the second operation apparatus 120 in Embodiment 1 according to the present invention.

As shown in FIG. 2, the display apparatus 100 includes a display unit 101 and a proxy obtainment unit 102. As shown in FIG. 3A, the first operation apparatus 110 includes a display unit 111, an operation receiving unit 112, a data obtainment unit 113, a data holding unit 114, and a data transmission unit 115. As shown in FIG. 36, the second operation apparatus 120 has a configuration similar to the configuration of the first operation apparatus 110, and includes a display unit 121, an operation receiving unit 122, a data obtainment unit 123, a data holding unit 124, and the data transmission unit 125.

It should be noted that the display unit 111, the operation receiving unit 112, the data obtainment unit 113, the data holding unit 114, and the data transmission unit 115 included in the first operation apparatus 110 respectively have the same functions as the display unit 121, the operation receiving unit 122, the data obtainment unit 123, the data holding unit 124, and the data transmission unit 125 included in the second operation apparatus 120. On this account, each of the processing units included in the first operation apparatus 110 is explained as follows, and explanations about the processing units included in the second operation apparatus 120 are omitted.

The display unit 101 of the display apparatus 100 receives display data transmitted from the first operation apparatus 110, and displays the received display data on the screen. To be more specific, the display unit 101 is a processing unit that displays the display data transmitted by the data transmission unit 115 on a display device such as an LCD (not illustrated). Generally speaking, in order to display video, a photograph, or the like with a high level of visual beauty and impact, it is preferable for the display unit 101 of the display apparatus 100 to display the data on a large high-resolution screen as compared to the display unit 111 of the first operation apparatus 110 and the display unit 121 of the second operation apparatus 120.

Moreover, it is preferable for the display device to be set at a position where a plurality of users can see the screen at the same time. It should be noted that the display device may be included in the display apparatus 100 or provided outside the display apparatus 100.

The proxy obtainment unit 102 of the display apparatus 100 obtains, from the first operation apparatus 110, an identifier that identifies operational information used for operating the display data displayed by the display unit 101. When receiving a request from the second operation apparatus 120 to obtain the operational information, the proxy obtainment unit 102 allows the second operation apparatus 120 to obtain the operational information specified by the identifier.

To be more specific, the proxy obtainment unit 102 obtains, as the identifier, storage location information regarding a storage location of the operational information held by the first operation apparatus 110. When receiving the request from the second operation apparatus 120 to obtain the operational information, the proxy obtainment unit 102 obtains the operational information from the storage location indicated by the storage location information. Then, the proxy obtainment unit 102 allows the second operation apparatus 120 to obtain the operational information by transmitting the obtained operational information to the second operation apparatus 120.

More specifically, when receiving a UI obtainment request from the data obtainment unit 123 of the second operation apparatus 120, the proxy obtainment unit 102 obtains an operational UI corresponding to the display data currently displayed by the display unit 101 from the data holding unit 114 of the first operation apparatus 110 and transmits the obtained operational UI to the data obtainment unit 123.

Moreover, when receiving a termination request from the first operation apparatus 110 to terminate display of the display data, the proxy obtainment unit 102 causes the second operation apparatus 120 to delete the operational information obtained by the second operation apparatus 120. To be more specific, when receiving the termination request to terminate display of the display data from the data transmission unit 115 of the first operation apparatus 110 that holds the operational UI, the proxy obtainment unit 102 requests the data obtainment unit 123 of the second operation apparatus 120, from which the UI obtainment request was received, to discard the operational UI.

As with the display unit 101, the display unit 111 of the first operation apparatus 110 is a processing unit that displays the display data on a display device such as an LCD (not illustrated). It should be noted that the display device may be included in the first operation apparatus 110 or provided outside the first operation apparatus 110.

The display unit 111 displays an operational UI held by the data holding unit 114, and changes the displayed details according to a user operation notified by the operation receiving unit 112. Moreover, when receiving a request to discard the operational UI from the data obtainment unit 113, the display unit 111 hides the operational UI that is currently being displayed and then discards the operational UI.

The operation receiving unit 112 is a processing unit, such as a touch panel or keys, that receives a user operation, and notifies the display unit 111 and the data transmission unit 115 of a result of the user operation.

The data obtainment unit 113 obtains the identifier received by the display apparatus 100, according to an obtainment request from a different operation apparatus operating the display data to the display apparatus 100 to obtain the operational information. To be more specific, according to the obtainment request, the data obtainment unit 113 obtains, from the display apparatus 100, the storage location information received by the display apparatus 100.

Moreover, the data obtainment unit 113 obtains the operational information, according to the obtainment request made of the display apparatus 100 to obtain the operational information. More specifically, according to the request from the display unit 111, the data obtainment unit 113 obtains the operational UI from the data holding unit 114 or the proxy obtainment unit 102 and transmits the obtained operational UI to the display unit 111.

Furthermore, the data obtainment unit 113 obtains a termination request to terminate display of the display data displayed by the display apparatus 100. When receiving a request from the proxy obtainment unit 102 to discard the operational UI, the data obtainment unit 113 requests the display unit 111 to discard the operational UI.

The data holding unit 114 holds an identifier that identifies operational information used for operating display data. To be more specific, the data holding unit 114 holds, as the identifier, storage location information regarding a storage location of the operational information in association with the display data and the operational information. Moreover, the data holding nit 114 holds the operational information obtained by the data obtainment unit 113.

More specifically, the data holding unit 114 includes a memory device, such as a HDD or a flash memory, and holds display data and an operational UI for operating the display data. Here, the display data refers to, for example: contents data such as text, images, and video; data showing a screen configuration where text, images, and video are combined, such as hypertext markup language (HTML); or a program performing a process corresponding to the process for operating the display data, such as Java (registered trademark) Script.

The operational UI is a program proving a user interface for operating the display data according to a user operation, and displays buttons for, for example, image enlargement, image reduction, video play, video stop, video fast-forward, and video rewind. It should be noted that a program for changing the display data according to an instruction from the operational UI is provided for at least one of the display apparatus 100, the first operation apparatus 110, and the second operation apparatus 120. Moreover, as with the operational UI, the display data may be a program that provides a user interface including user interaction.

FIG. 4 is a diagram showing details of data held by the data holding unit 114 in Embodiment 1 according to the present invention.

As shown in this diagram, the data holding unit 114 holds each piece of display data, operational information indicating an operational UI for operating the display data, and storage location information indicating a storage location of the operational UI, in association with each other.

The data transmission unit 115 allows the display apparatus 100 to obtain the display data, and transmits the identifier held by the data holding unit 114 to the display apparatus 100. To be more specific, the data transmission unit 115 transmits, to the display apparatus 100, the display data and the storage location information held by the data holding unit 114.

More specifically, according to the user operation notified by the operation receiving unit 112, the data transmission unit 115 notifies the display unit 101 of the display apparatus 100 via the communication network, of the display data and the storage location of the operational UI for operating the display data that are held by the data holding unit 114.

When the data obtainment unit 113 obtains the identifier, the data transmission unit 115 transmits the operational information specified by this identifier to allow a different operation apparatus to obtain the operational information. To be more specific, when the data obtainment unit 113 obtains the storage location information from the display apparatus 100, the data transmission unit 115 allows the different operation apparatus to obtain the operational information via the display apparatus 100 by transmitting, to the display apparatus 100, the operational information corresponding to the storage location information held by the data holding unit 114.

When the data obtainment unit 113 receives a termination request to terminate display of the display data, the data transmission unit 115 transmits the termination request to terminate display of the display data to the display apparatus 100 and causes the different operation apparatus to discard the operational information obtained by the different operation apparatus. To be more specific, when the user instructs via the operation receiving unit 112 that display of the display data should be terminated, the data transmission unit 115 requests the proxy obtainment unit 102 of the display apparatus 100, to which the display data was transmitted, to discard the operational UI.

Moreover, when the data obtainment unit 113 receives the termination request, the data transmission unit 115 causes the display apparatus 100 to discard the identifier held by the display apparatus 100. To be more specific, when the user instructs that display of the display data should be terminated, the data transmission unit 115 causes the display apparatus 100 to discard the storage location information that the display apparatus 100 obtained from the first operation apparatus 110 and holds.

Furthermore, the data transmission unit 115 transmits, to the display apparatus 100, the data for changing the display data currently displayed by the display apparatus 100 using the operational information held by the data holding unit 114. It should be noted that the second operation apparatus 120 is operated by a user different from the user operating the first operation apparatus 110.

The following describes a flow of a process performed when a user A operating the first operation apparatus 110 causes the display apparatus 100 to display the display data held by the first operation apparatus 110.

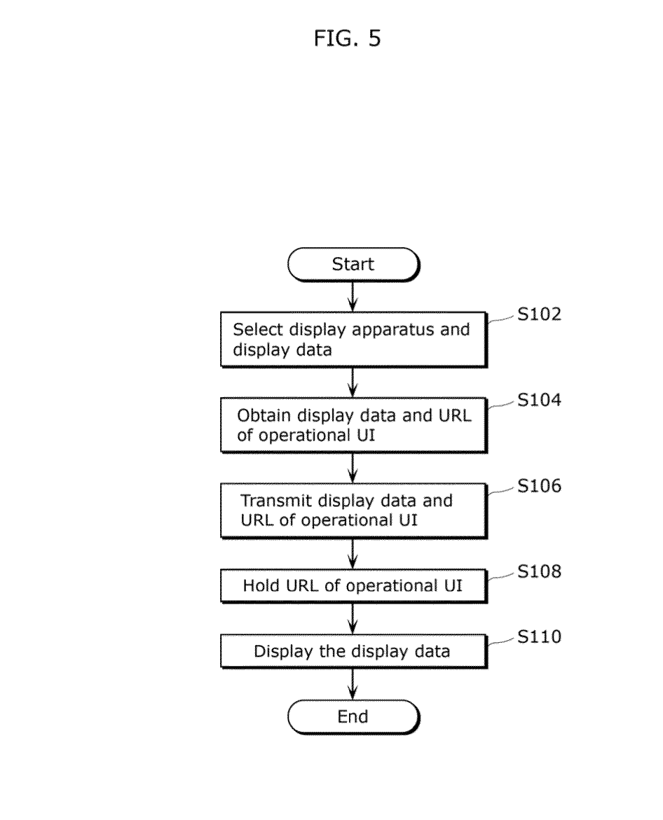

FIG. 5 is a flowchart showing a process performed when the first operation apparatus 110 causes the display apparatus 100 to display the display data, in Embodiment 1 according to the present invention.

As shown in this diagram, when the user A operating the first operation apparatus 110 selects the display data to be transmitted and specifies the display apparatus 100 as a transmission destination, the operation receiving unit 112 notifies the data transmission unit 115 of the selected display data and the display apparatus 100 as the transmission destination (S102).

To be more specific, the user A operating the first operation apparatus 100 causes, via the operation receiving unit 112, the display unit 111 to display a list of display data held by the data holding unit 114. Then, from the list, the user selects the display data that the user A wishes to display on a different apparatus. Moreover, the user A causes the display unit 111 to display a list of apparatuses connected via the communication network. Then, from the list, the user A selects the apparatus (the display apparatus 100 in Embodiment 1) as the transmission destination.

Next, the data transmission unit 115 obtains, from the data holding unit 114, the display data selected via the operation receiving unit 112 and a uniform resource locator (URL) of an operational UI corresponding to the display data (S104).

Here, the URL of the operational UI is a combination of an IP address of the first operation apparatus 110 and a path indicating a storage location in the data holding unit 114. As an example, when display data 1 shown in FIG. 4 is selected by the user, the data transmission unit 115 obtains the display data 1 and a URL 1 of an operational UI 1 from the data holding unit 114.

Next, the data transmission unit 115 transmits the display data and the URL of the operational UI corresponding to the display data that are obtained from the data holding unit 114, to the display unit 101 of the apparatus specified as the transmission destination by the user via the communication network (S106). In Embodiment 1, the display data 1 and the URL 1 of the operational UI 1 are transmitted to the display unit 101 of the display apparatus 100.

Following this, when receiving the display data and the URL 1 of the operational UI from the data transmission unit 115 of the first operation apparatus 110, the display unit 101 of the display apparatus 100 notifies the proxy obtainment unit 102 of the received URL 1 of the operational UI. Then, the proxy obtainment unit 102 holds the notified URL 1 (S108).

After this, the display unit 101 displays the received display data on the screen (S110). When the user wishes to change the data to be displayed on the display apparatus 100 later, the process from S102 to S110 is repeated to update the display data to be displayed on the display apparatus 100. It should be noted that in the case where the apparatus once selected as the transmission destination is not changed, the process of selecting the apparatus may be omitted and the data may be transmitted again to the apparatus to which the data was transmitted the last time.

The following describes a flow of a process performed when a user B operating the second operation apparatus 120 obtains an operational UI to operate the display data displayed on the display apparatus 100.

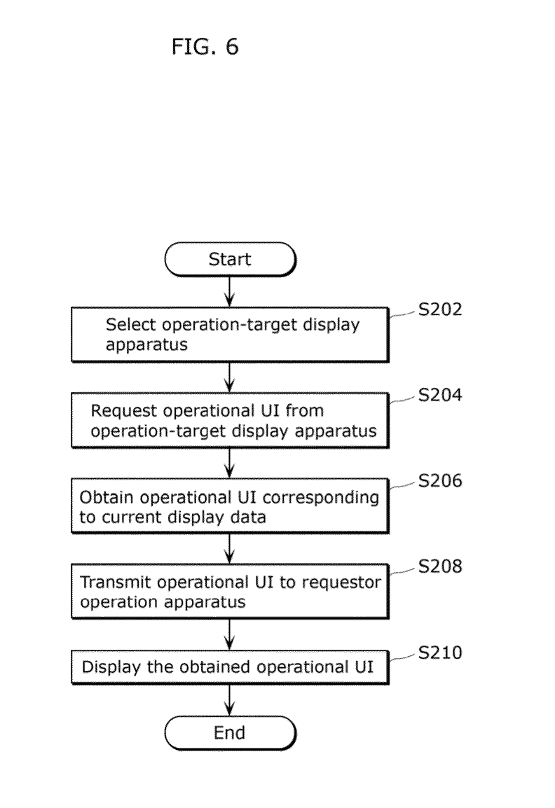

FIG. 6 is a flowchart showing a process performed by the second operation apparatus 120 to display an operational UI, in Embodiment 1 according to the present invention.

As shown in this diagram, when the user B operating the second operation apparatus 120 selects the display apparatus displaying the target data that the user B wishes to operate using an operational UI, the operation receiving unit 122 notifies the data obtainment unit 123 about the selected display apparatus as the operation target (S202).

To be more specific, the user B operating the second operation apparatus 120 causes, via the operation receiving unit 122, the display unit 121 to display a list of apparatuses connected to the communication network. Then, from the list, the user B selects the apparatus (the display apparatus 100 in Embodiment 1) as the operation target.

When notified by the operation receiving unit 122 about the display apparatus 100 as the operation target, the data obtainment unit 123 requests an operational UI from the proxy obtainment unit 102 of the display apparatus 100 via the communication network (S204).

When receiving the request for the operational UI from the data obtainment unit 123, the proxy obtainment unit 102 of the display apparatus 100 obtains the operational UI from the data holding unit 114 of the first operation apparatus 110 via the communication network, based on the URL of the operational UI corresponding to the display data currently being displayed by the display unit 101 of the display apparatus 100 (S206).

When the display data 1 is displayed on the display unit 101 of the display apparatus 100 as an example, the proxy obtainment unit 102 stores, in S108 shown in FIG. 5, the URL 1 of the operational UI 1 held by the first operation apparatus 110. On account of this, the proxy obtainment unit 102 obtains the operational UI 1 from the data holding unit 114 of the first operation apparatus 110.

Next, the proxy obtainment unit 102 transmits, via the communication network, the operational UI to the data obtainment unit 123 of the second operation apparatus 120 from which the request for the operational UI was received (S208).

Lastly, the data obtainment unit 123 of the second operation apparatus 120 notifies the display unit 121 of the received operational UI. Then, the display unit 121 displays the received operational UI (S210).

With the above process, the operational UI corresponding to the display data currently being displayed by the display apparatus 100 is displayed by the second operation apparatus 120. Thus, via this operational UI, the user B can operate the display data displayed by the display apparatus 100 as well.

As a specific example, a process of operating the display data displayed by the display apparatus 100 via the operational UI displayed by the display unit 121 of the second operation apparatus 120 is explained. For example, suppose that the display data is image data and that the operational UI includes an enlargement button, a reduction button, and a switch button for switching to a next photograph. In this case, the operation receiving unit 122 is notified that the user presses a button on the display unit 121 displaying the operational UI. Then, the display unit 121 notifies the display unit 101 of the display apparatus 100 about an instruction corresponding to the pressed button. Thus, the display unit 101 changes the currently displayed data according to the instruction.

For example, when the enlargement button or the reduction button is pressed, the display unit 101 enlarges or reduces the displayed photograph and displays the resulting photograph. When the switch button for switching to a next photograph is pressed, the display unit 101 requests the next photograph from the data transmission unit 115 of the first operation apparatus 110. Then, the data transmission unit 115 performs again the process from S104 shown in FIG. 5 and, as a result, the display data displayed on the display apparatus 100 is changed (that is, the next photograph is displayed in Embodiment 1).

In the case where the display data is video, a play button, a stop button, a fast-forward button, and a rewind button are provided instead of the enlargement and reduction buttons. When one of these buttons is pressed, a request corresponding to the instruction is transmitted to the display unit 101 of the display apparatus 100. Then, the display unit 101 updates the currently displayed data according to the request. Here, when an operation needs to be performed on the first operation apparatus 110 holding the display data, such as when streaming playback is requested, the display unit 101 requests the data transmission unit 115 of the first operation apparatus 110 to change the data transmission method (play, stop, fast-forward, or rewind).

The following describes a flow of a process performed when the user A operating the first operation apparatus 110 terminates display of the display data currently displayed on the display apparatus 100.

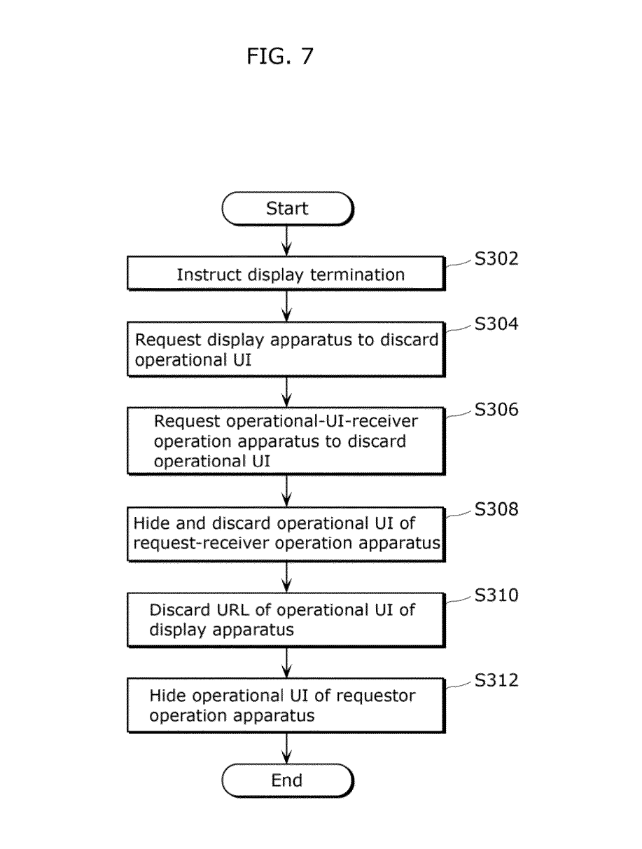

FIG. 7 is a flowchart showing a process performed by the first operation apparatus 110 to terminate display of the display data, in Embodiment 1 according to the present invention.

As shown in this diagram, when the user A instructs via the operation receiving unit 112 that display of the display data should be terminated (S302), the data transmission 115 requests the proxy obtainment unit 102 of the display apparatus 100, to which the display data was transmitted, to discard the operational UI (S304).

Then, upon receiving the request, the proxy obtainment unit 102 requests the data obtainment unit 123 of the second operation apparatus 120, from which the proxy obtainment of the operational UI was requested, to discard the operational UI (S306).

Upon receiving the request, the data obtainment unit 123 of the second operation apparatus 120 hides the operational UI that is currently being displayed by the display unit 121 and then requests the data holding unit 124 to discard the held operational UI (S308). It should be noted that when the proxy obtainment is requested from a plurality of operation apparatuses, the operational UI is discarded from all of the operation apparatuses by repeating the process from S306 to S308.

Moreover, the data transmission unit 115 requests the display apparatus 100 to discard the URL of the operational UI held by the display apparatus 100 (S310). Accordingly, the proxy obtainment unit 102 of the display apparatus 100 discards the URL of the held operational UI.

It should be noted that the proxy obtainment unit 102 may discard the URL of the held operational UI when requested by the data transmission unit 115 to discard the operational UI because of the request from the user A to terminate display of the display data.

Lastly, according to the display termination request received by the operation receiving unit 112 of the first operation apparatus 110, the operational UI currently being displayed by the display unit 111 is hidden (S312) and the process is terminated here.

The following describes a flow of a series of processes performed by the display apparatus 100, the first operation apparatus 110, and the second operation apparatus 120.

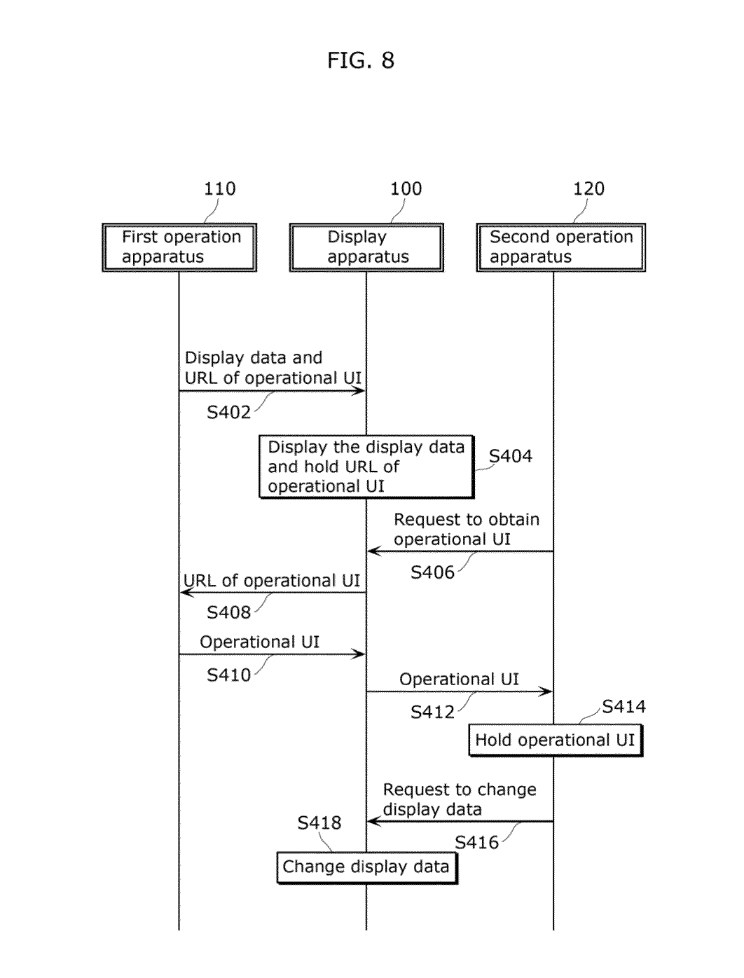

FIG. 8 is a sequence diagram showing processes performed by the display apparatus 100, the first operation apparatus 110, and the second operation apparatus 120, in Embodiment 1 according to the present invention.

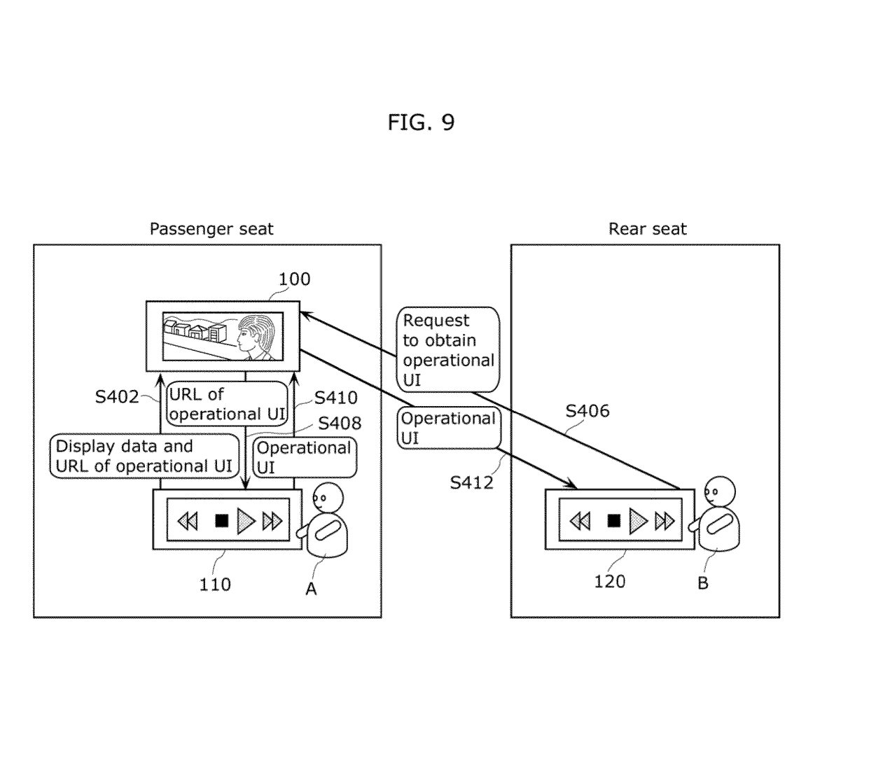

FIG. 9 is a diagram explaining the processes performed by the display apparatus 100, the first operation apparatus 110, and the second operation apparatus 120, in Embodiment 1 according to the present invention.

In FIG. 9: the display apparatus 100 is shown as being provided for a passenger seat of a car; the first operation apparatus 110 is shown as, for example, a smartphone provided for the passenger seat of the car; and the second operation apparatus 120 is shown as, for example, a smartphone provided for a rear seat. The first operation apparatus 110 is operated by the user A and the second operation apparatus 120 is operated by the user B.

As shown in FIG. 8 and FIG. 9, by an operation of the user A, the first operation apparatus 110 firstly transmits, to the display apparatus 100, the display data and the URL of the operational UI that is the identifier for identifying the operational information held by the data holding unit 114 (S402). Then, the display apparatus 100 receives the display data and the URL of the operational UI transmitted by the first operation apparatus 110.

Next, the display apparatus 100 displays the received display data on the display unit 101 and allows the proxy obtainment unit 102 to hold the received URL of the operational UI (S404).

Then, according to the instruction of the user B, the second operation apparatus 120 requests the display apparatus 100 to obtain the operational UI that is the operational information (S406).

The display apparatus 100 receives the request to obtain the operational UI and transmits, to the first operation apparatus 110, the URL of the operational UI received from the first operation apparatus 110, so that the first operation apparatus 110 obtains the URL of the operational UI (S408).

Using the URL of the operational UI obtained from the display apparatus 100, the first operation apparatus 110 obtains the operational UI indicated by the URL and transmits the operational UI (S410).

Then, the display apparatus 100 receives the operational UI transmitted from the first operation apparatus 110 and transmits the received operational UI to the second operation apparatus 120. As a result, the second operation apparatus 120 obtains the operational UI transmitted from the first operation apparatus 110 (S412).

The second operation apparatus 120 allows the data holding unit 124 to hold the obtained operational UI (S414).

Then, using the operational UI held by the data holding unit 124, the second operation apparatus 120 transmits, to the display apparatus 100, the data for changing the display data displayed by the display apparatus 100 (S416). To be more specific, the user B requests the second operation apparatus 120, via the operational UI, to change the display data displayed by the display apparatus 100.

According to the request, the display apparatus 100 changes the currently displayed data (S418).

As described thus far, with the display apparatus 100 in Embodiment 1 according to the present invention, the proxy obtainment unit 102 obtains, from the first operation apparatus 110, the identifier that identifies the operational information and, when receiving a request from the second operation apparatus 120 to obtain the operational information, allows the second operation apparatus 120 to obtain the operational information specified by the identifier. Thus, the user may simply select the display apparatus 100 that displays the display data which the user wishes to operate, using the second operation apparatus 120. As a result, the second operation apparatus 120 obtains the operational information including the corresponding operational UI, and the user thus can operate the display data using this operational UI. More specifically, the user can operate the desired display data through a simple operation of selecting the display apparatus 100, without regard to locations where the display data displayed by the display apparatus 100 and the operational UI for operating this display data are stored. In this way, since the operation apparatus operated by the user obtains the operational information, the user can operate the display data without knowing which apparatus holds the display data and the operational information.

Moreover, the operational UI corresponding to the display data displayed by the display apparatus 100 is obtained via the proxy obtainment unit 102 of the display apparatus 100. This can prevent an operational UI corresponding display data other than the display data shown to a different user for shared use via the display apparatus 100, from being obtained against intentions of the user, and also prevent the unintended display data from being operated.

Furthermore, the proxy obtainment unit 102 of the display apparatus 100 obtains, as the identifier that identifies the operational information, the storage location information regarding the storage location of the operational information held by the first operation apparatus 110. Then, the proxy obtainment unit 102 obtains the operational information from the storage location of the operational information indicated by the storage location information and transmits the operational information to the second operation apparatus 120. To be more specific, the proxy obtainment unit 102 allows the second operation apparatus 120 to obtain the operational information by directly transmitting the operational information to the second operation apparatus 120. Thus, the operation apparatus operated by the user can obtain the operational information. Therefore, the user can operate the display data without knowing which apparatus holds the display data and the operational information.

Moreover, when receiving a request from the first operation apparatus 110 to terminate display of the display data, the proxy obtainment unit 102 of the display apparatus 100 causes the second operation apparatus 120 to delete the held operational information. To be more specific, when display on the display apparatus 100 is terminated, the data transmission unit 115 causes the operational UI transmitted to the different apparatus to be deleted via the proxy obtainment unit 102. Thus, an operation via the operational UI can be prevented from being performed at timing that is against intentions of the user, such as when the operational UI is operated by a different user after the termination of display.

Furthermore, with the first operation apparatus 110 in Embodiment 1 according to the present invention, the data transmission unit 115 transmits, to the display apparatus 100, the identifier that identifies the operational information held by the data holding unit 114. After this, when obtaining the identifier, the data transmission unit 115 transmits the operational information specified by the identifier to allow a different operation apparatus, i.e., the second operation apparatus 120, to obtain the operational information. Thus, the user may simply select the display apparatus 100 that displays the display data which the user wishes to operate, using the different operation apparatus, i.e., the second operation apparatus 120. As a result, the different operation apparatus obtains the operational information including the corresponding operational UI, and the user thus can operate the display data using this operational UI. More specifically, the user can operate the desired display data through a simple operation of selecting the display apparatus 100, without regard to locations where the display data displayed by the display apparatus and the operational UI for operating this display data are stored. In this way, since the operation apparatus operated by the user obtains the operational information, the user can operate the display data without knowing which apparatus holds the display data and the operational information.

Moreover, the data transmission unit 115 of the first operation apparatus 110 transmits, to the display apparatus 100, the storage location information regarding the storage location of the operational information held by the data holding unit 114, as the identifier that identifies the operational information. After this, when the data obtainment unit 113 obtains the storage location information from the display apparatus 100, the data transmission unit 115 transmits the operational information corresponding to the storage location information to the display apparatus 100. To be more specific, when the data transmission unit 115 transmits the operational information to the display apparatus 100 and the display apparatus 100 transmits the operational information to the different operation apparatus, the second operation apparatus 120 can obtain the operational information. Thus, since the operation apparatus operated by the user obtains the operational information, the user can operate the display data without knowing which apparatus holds the display data and the operational information.

Furthermore, when the data obtainment unit 113 of the first operation apparatus 110 receives the termination request to terminate display of the display data, the data transmission unit 115 causes the different operation apparatus to delete the held operational information. To be more specific, since the operational information is deleted after display of the display data is terminated, an operation via the operational UI can be prevented from being performed at timing that is against intentions of the user, such as when the operational UI is operated by a different user.

Moreover, when the data obtainment unit 113 receives the termination request to terminate display of the display data, the data transmission unit 115 causes the display apparatus 100 to delete the held operational information. More specifically, the storage location information held by the display apparatus 100 is deleted after display of the display data is terminated. Therefore, even when a request is received from a different user to obtain the operational information, the operational UI is prevented from being obtained by this different user via the display apparatus 100. Moreover, an operation via the operational UI can be prevented from being performed at timing against intentions of the user.

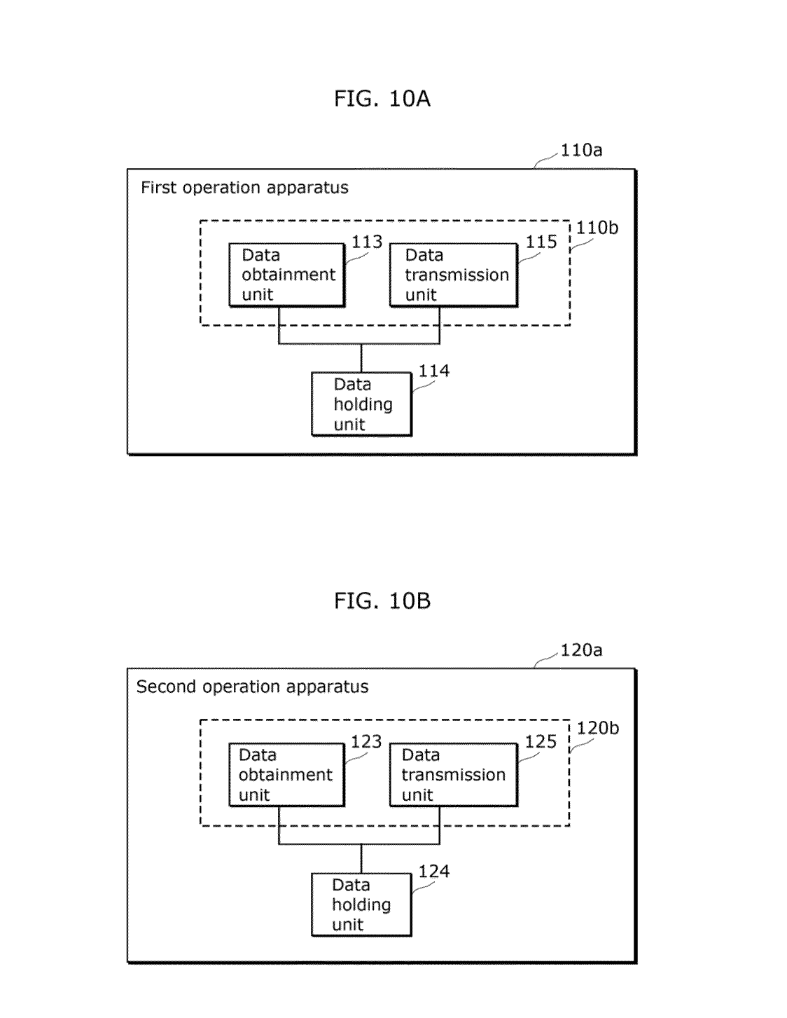

In Embodiment 1, the first operation apparatus 110 and the second operation apparatus 120 have the same configuration in order to perform the same operation bidirectionally. However, it should be noted that each of these apparatuses may include only the necessary processing units. For example, as shown in FIG. 10A, a first operation apparatus 110a may be configured to include a data obtainment unit 113, a data holding unit 114, and a data transmission unit 115. Moreover, as shown in FIG. 10B, a second operation apparatus 120a may be configured to include a data obtainment unit 123, a data holding unit 124, and a data transmission unit 125. Note that FIG. 10A and FIG. 10B show minimum configurations of the first operation apparatus and the second operation apparatus, respectively, in Embodiment 1 according to the present invention.

In Embodiment 1, the user A operates the first operation apparatus 110. However, the display apparatus 100 may include, for example, the operation receiving unit 112 and the data holding unit 114 of the first operation apparatus 110. In this case, the user A may directly operate the display apparatus 100.

Suppose that the target operation apparatus 1100 connected to the communication network as in the system configuration shown in FIG. 17. In this case, the functions of the data transmission unit 115 and the data holding unit 114 of the first operation apparatus 110 may be arranged in the target operation apparatus 1100. Thus, the display unit 111 of the first operation apparatus 110 operated by the user A may request the data transmission unit and the data holding unit of the target operation apparatus 1100 to allow the display data to be displayed on the display apparatus 100.

In this case, note that the proxy obtainment unit 102 stores the IP address of the target operation apparatus 1100 and the directory path of the data holding unit, as the URL of the operational UI corresponding to the display data currently being displayed. Thus, when a request for the operational UI is received from the second operation apparatus 120, the operational UI corresponding to the display data held by the data holding unit of the target operation apparatus 1100 is transmitted.

Moreover, when the data holding unit 124 of the second operation apparatus 120 holds the operational UI in advance, the data transmission unit 115 notifies the display apparatus 100 of, for example, a UI type and an ID for identifying the operational UI instead of the URL of the operational UI corresponding to the display data. Then, when receiving a request to obtain the operational UI from the data obtainment unit 123 of the second operation apparatus 120, the proxy obtainment unit 102 notifies the data obtainment unit 123 of, for example, the UI type and the ID for identifying the notified operational UI instead of the operational UI itself. Thus, based on the type and ID notified by the proxy obtainment unit 102, the data obtainment unit 123 may obtain the operational UI from the data holding unit 124 included in the same apparatus that includes the data obtainment unit 123 (that is, the second operation apparatus 120). In this case, the display apparatus 100 may include the function of the data holding unit 114. With this, the first operation apparatus 110 may transmit, instead of the display data, only information identifying the display data to be displayed, out of the display data held by the data holding unit of the display apparatus 100.

In Embodiment 1, when the display data of the display apparatus 100 is operated from the second operation apparatus 120 and an instruction also needs to be transmitted to the first operation apparatus 110 holding the display data, the instruction is transmitted to the data transmission unit 115 of the first operation apparatus 110 via the display unit 101 of the display apparatus 100. However, information about the apparatus (namely, the first operation apparatus 110) holding the display data may also be notified together with the operational UI to the second operation apparatus 120. With this, the second operation apparatus 120 may transmit the instruction directly to the data transmission unit 115 of the first operation apparatus 110.

In Embodiment 1, the operational UI displayed by the second operation apparatus 120 is the same as the operational UI displayed by the first operation apparatus 110. However, when an operation is performed from a different apparatus, a different operational UI may be transmitted in order to limit an operable range. To be more specific, the data holding unit 114 may hold, as the identifier of the operational UI, an identifier that identifies the operational information in which a predetermined operation is not permitted.

For example, when receiving a request to obtain the operational UI from a different apparatus, the first operation apparatus 110 determines that the request-source apparatus that directly transmits the request is an owner user of the operational UI and of the display data that knows the storage location of the operational UI. Moreover, the first operation apparatus 110 determines that the request-source apparatus that indirectly transmits the request via the display apparatus 100 is a guest user that does not know the storage location of the operational UI, and thus transmits an operational UI having a different operable range.

Here, the first operation apparatus 110 may transmit, to the guest user, the operational UI having the limited operable range as compared to the operational UI transmitted to the owner user even though both of these operational UIs are displayed in the same manner.

With this, the data transmission unit 115 of the first operation apparatus 110 allows the different operation apparatus to obtain the operational information in which the predetermined operation is not permitted. Thus, the user cannot perform the predetermined operation on the display data even with the different operation apparatus. Hence, changes made to the display data by the operation apparatus are limited. This can prevent a change to the display data from being made against intentions of the user.

In Embodiment 1, the second operation apparatus 120 obtains the operational UI via the display apparatus 100. However, as described below, the second operation apparatus 120 may obtain the operational UI directly from the first operation apparatus 110.

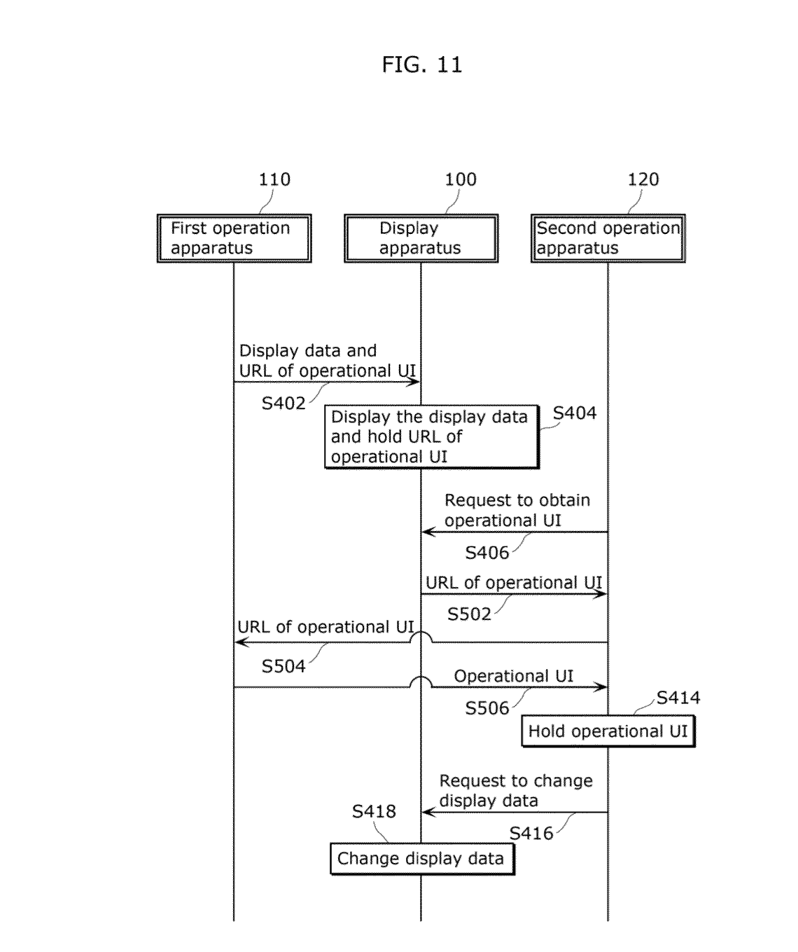

FIG. 11 is a sequence diagram showing processes performed by a display apparatus 100, a first operation apparatus 110, and a second operation apparatus 120, in Modification of Embodiment 1 according to the present invention.

As shown in this diagram, the first operation apparatus 110 firstly transmits the display data and the URL of the operational UI to the display apparatus 100 (S402). The display apparatus 100 displays the display data and also holds the URL of the operational UI (S404). The second operation apparatus 120 requests the display apparatus 100 to obtain the operational UI (S406). Note that these processes are the same as those shown in FIG. 8 and, therefore, the detailed description is omitted here.

Then, the proxy obtainment unit 102 of the display apparatus 100 requested to obtain the operational UI transmits the URL of the operational UI to the second operation apparatus 120 (S502).

The second operation apparatus 120 thus receives the URL of the operational UI and, with reference to the URL, transmits the URL of the operational UI to the first operation apparatus 110 holding the operational UI (S504). With this, the data obtainment unit 113 of the first operation apparatus 110 obtains, from the second operation apparatus 120, the URL of the operational UI received by the display apparatus 100 and transmitted to the second operation apparatus 120.

Then, the data transmission unit 115 of the first operation apparatus 110 transmits, to the second operation apparatus 120, the operational UI corresponding to the URL of the operational UI held by the data holding unit 114 (S506).

Following this, the second operation apparatus 120 allows the data holding unit 124 to hold the obtained operational UI (S414) and requests the display apparatus 100 to change the display data using this operational UI (S416). Thus, the display apparatus 100 changes the currently displayed data (S418). Note that these processes are the same as those shown in FIG. 8 and, therefore, the detailed description is omitted here.

As described thus far, with the display device 100 in Modification of Embodiment 1 according to the present invention, the proxy obtainment unit 102 obtains, as the identifier that identifies the operational information, the storage location information regarding the storage location of the operational information held by the first operation apparatus 110. Then, the proxy obtainment unit 102 transmits the operational information to the second operation apparatus 120. To be more specific, the proxy obtainment unit 102 allows the second operation apparatus 120 to obtain the operational information from the storage location information, by transmitting the operational information to the second operation apparatus 120. Thus, the operation apparatus operated by the user can obtain the operational information. Therefore, the user can operate the display data without knowing which apparatus holds the display data and the operational information.

Moreover, with the first operation apparatus 110 in Modification of Embodiment 1 according to the present invention, the data transmission unit 115 transmits, to the display apparatus 100, the storage location information regarding the storage location of the operational information held by the data holding unit 114, as the identifier that identifies the operational information. After this, when the data obtainment unit 113 obtains the storage location information from the second operation apparatus 120, the data transmission unit 115 transmits the operational information corresponding to the storage location information to the second operation apparatus 120. To be more specific, when the data transmission unit 115 allows the second operation apparatus 120 to obtain the operational information by directly transmitting the operational information to the second operation apparatus 120. Thus, since the operation apparatus operated by the user obtains the operational information, the user can operate the display data without knowing which apparatus holds the display data and the operational information.

In Embodiment 1 and Modification of Embodiment 1 according to the present invention, the data holding unit 114 of the first operation apparatus 110 holds both the operational UI and the URL of the operational UI and the second operation apparatus 120 receives the operational UI obtained from the URL of the operational UI. However, the data holding unit 114 may hold the URL of the operational UI, and the operational UI may be held by a different apparatus. Thus, using the URL of the operational UI, the second operation apparatus 120 may obtain the operational UI from the different apparatus.

### Embodiment 2

The following describes an apparatus coordination control system 11 in Embodiment 2 according to the present invention.

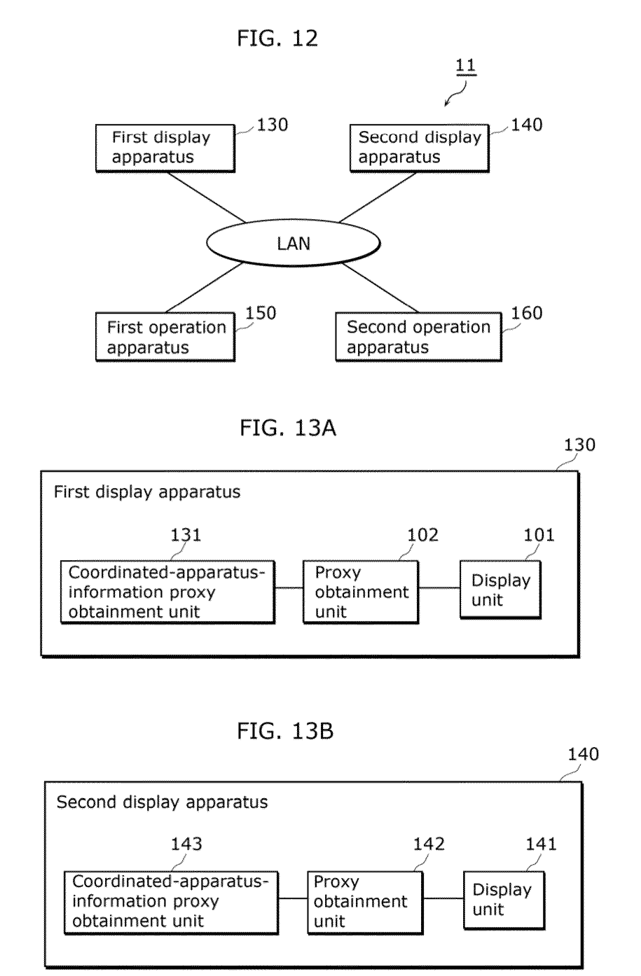

FIG. 12 is a diagram showing a configuration of the apparatus coordination control system 11 in Embodiment 2 according to the present invention.

As shown in this diagram, the apparatus coordination control system 11 includes two display apparatuses and two operation apparatuses. The two display apparatuses are a first display apparatus 130 and a second display apparatus 140. The two operation apparatuses are a first operation apparatus 150 and a second operation apparatus 160.

As with the display apparatus 100, each of the first display apparatus 130 and the second display apparatus 140 displays display data. Embodiment 2 assumes that, since it is difficult to watch one display apparatus from, for example, the driver's seat, the passenger seat, and the rear seat of a car, the two display apparatuses such as a passenger-seat display apparatus and a rear-seat display apparatus display the same display data to be shared.

FIG. 13A is a diagram showing a configuration of the first display apparatus 130 in Embodiment 2 according to the present invention. FIG. 13B is a diagram showing a configuration of the second display apparatus 140 in Embodiment 2 according to the present invention.

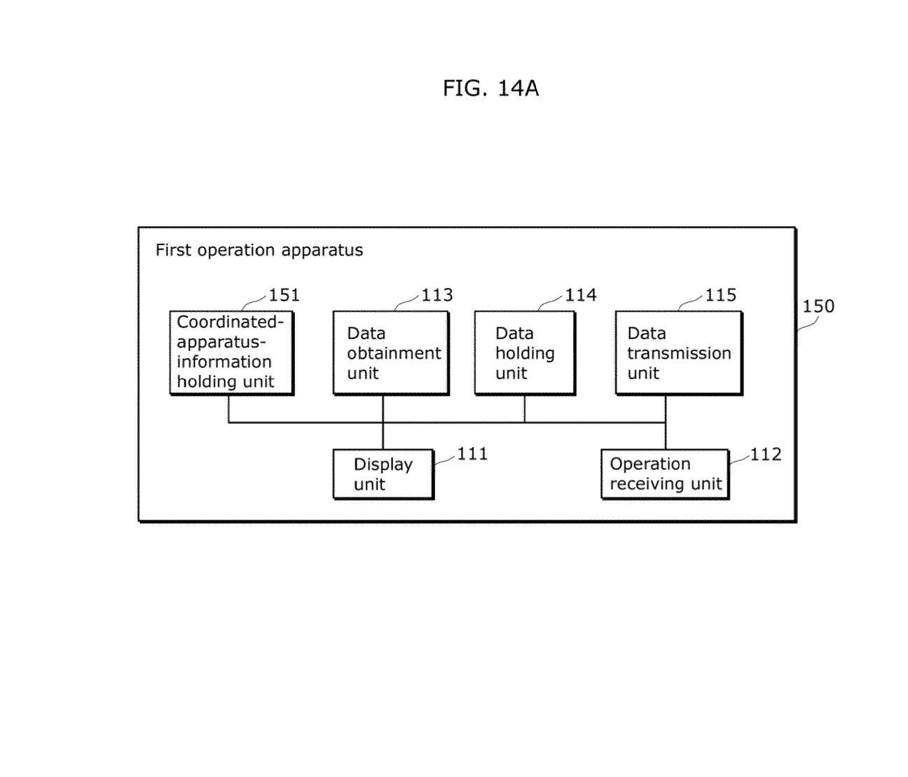

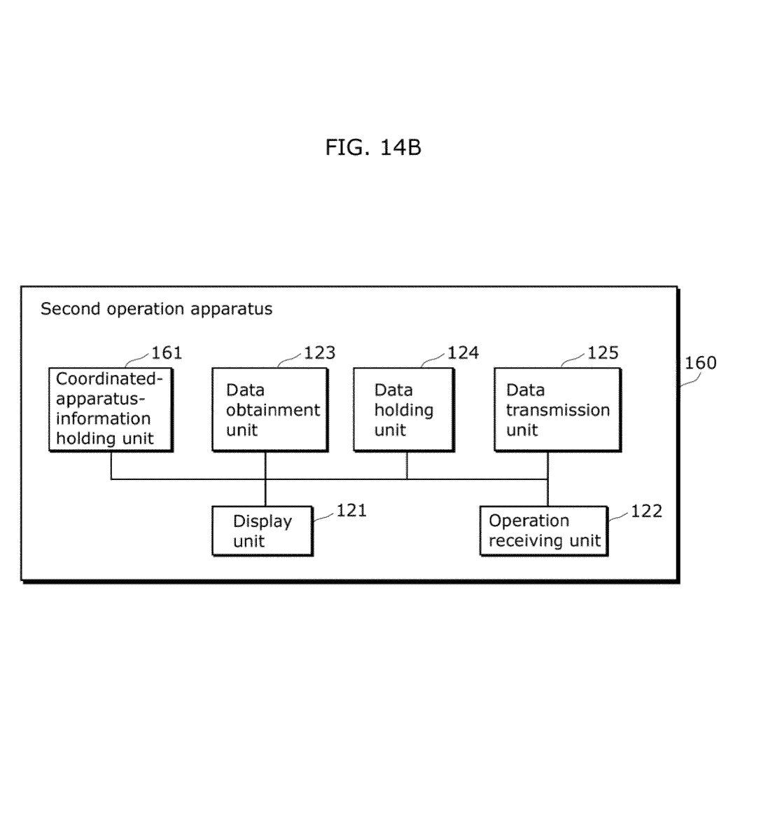

FIG. 14A is a diagram showing a configuration of the first operation apparatus 150 in Embodiment 2 according to the present invention. FIG. 148 is a diagram showing a configuration of the second operation apparatus 160 in Embodiment 2 according to the present invention.

As shown in FIG. 13A, the first display apparatus 130 includes a display unit 101, a proxy obtainment unit 102, and a coordinated-apparatus-information proxy obtainment unit 131. As shown in FIG. 13B, the second display apparatus 140 includes a display unit 141, a proxy obtainment unit 142, and a coordinated-apparatus-information proxy obtainment unit 143.

As shown in FIG. 14A, the first operation apparatus 150 includes a display unit 111, an operation receiving unit 112, a data obtainment unit 113, a data holding unit 114, a data transmission unit 115, and a coordinated-apparatus-information holding unit 151. As shown in FIG. 14B, the second operation apparatus 160 has a configuration similar to the configuration of the first operation apparatus 150, and includes a display unit 121, an operation receiving unit 122, a data obtainment unit 123, a data holding unit 124, a data transmission unit 125, and a coordinated'-apparatus-information holding unit 161.

It should be noted that, in FIG. 13A, the display unit 101 and the proxy obtainment unit 102 that are identical to those shown in FIG. 2 are assigned the same reference signs as used in FIG. 2 and that the detailed explanations of these units are omitted here. Also note that the display unit 141, the proxy obtainment unit 142, and the coordinated-apparatus-information proxy obtainment unit 143 of the second display apparatus 140 have the respective same functions as the display unit 101, the proxy obtainment unit 102, and the coordinated-apparatus-information proxy obtainment unit 131 of the first display apparatus 130 and, therefore, the detailed explanations of these units are not repeated.

It should be noted that, in FIG. 14A, the display unit 111, the operation receiving unit 112, the data obtainment unit 113, the data holding unit 114, and the data transmission unit 115 that are identical to those shown in FIG. 3A are assigned the same reference signs as used in FIG. 3A and that the detailed explanations of these units are omitted here. Similarly, note that, in FIG. 14B, the display unit 121, the operation receiving unit 122, the data obtainment unit 123, the data holding unit 124, and the data transmission unit 125 that are identical to those shown in FIG. 3B are assigned the same reference signs as used in FIG. 3B and that the detailed explanations of these units are omitted here. Also note that the coordinated-apparatus-information holding unit 151 of the first operation apparatus 150 has the same function as the coordinated-apparatus-information holding unit 161 of the second operation apparatus 160 and, therefore, the detailed explanation is not repeated.

When notified by the proxy obtainment unit 102 about the operation apparatus from which the operational UI is to be obtained, the coordinated-apparatus-information proxy obtainment unit 131 of the first display apparatus 130 obtains coordinated-apparatus information held by the coordinated-apparatus-information holding unit of the notified operation apparatus. In the present example, the coordinated-apparatus-information proxy obtainment unit 131 obtains, as the coordinated-apparatus information, first display apparatus information indicating the first display apparatus 130 and second display apparatus information indicating the second display apparatus 140.

The data obtainment unit 113 obtains the operational information according to a request to obtain the operational information for operating the display data to be displayed on the first display apparatus 130 or the second display apparatus 140. Moreover, the data obtainment unit 113 obtains the first display apparatus information indicating the first display apparatus 130 and the second display apparatus information indicating the second display apparatus 140, from a different operation apparatus via the first display apparatus 130 or the second display apparatus 140.

The data holding unit 114 holds the operational information obtained by the data obtainment unit 113.

The coordinated-apparatus-information holding unit 151 includes a primary storage device, such as a synchronous dynamic random access memory (SDRAM), and holds information regarding the display apparatus to which the data transmission unit 115 transmitted the display data. The information regarding the display apparatus includes an ID, a name, and an IP address for identifying the current apparatus and services provided by the current apparatus (such as capabilities of displaying the display data and of holding the display data). In the present example, the coordinated-apparatus-information holding unit 151 holds the first display apparatus information and the second display apparatus information obtained by the data obtainment unit 113.

The data transmission unit 115 transmits, to the first display apparatus 130 and the second display apparatus 140, data for changing, using the operational information held by the data holding unit 114, the display data displayed by the first display apparatus 130 and the second display apparatus 140 indicated by the first display apparatus information and the second display apparatus information held by the coordinated-apparatus-information holding unit 151.

The following describes a flow of a process performed when a user A operating the first operation apparatus 150 causes the first display apparatus 130 and the second display apparatus 140 to display the display data held by the first operation apparatus 150.

When the display data is to be displayed by the first display apparatus 130, the process is the same as in the flow shown in FIG. 5 in Embodiment 1. In S106 of the present case, when transmitting the display data and the URL of the operational UI to the first display apparatus 130, the data transmission unit 115 stores, into the coordinated-apparatus-information holding unit 151, the information indicating the first display apparatus 130 that is the transmission destination.

When the display data is to be displayed by the second display apparatus 140, the process is also basically the same as in the flow shown in FIG. 5 in Embodiment 1. However, in S102 in the present case, an operation to select the display data is omitted and the first operation apparatus 150 causes the display data displayed on the first display apparatus 130 to also be displayed on the second display apparatus 140.

In this case, as in the case where the display data is displayed by the first display apparatus 130, the data transmission unit 115 stores, into the coordinated-apparatus-information holding unit 151, the information indicating the second display apparatus 140 that is the transmission destination in S106. As a result, the coordinated-apparatus-information holding unit 151 stores the information indicating the first display apparatus 130 and the information indicating the second display apparatus 140.

Thus, when the user A operates the display data using the operational UI of the first operation apparatus 150, an instruction is transmitted to both the first display apparatus 130 and the second display apparatus 140 indicated by the information held by the coordinated-apparatus-information holding unit 151. As a result, the display data pieces displayed by the two display apparatuses are updated together.

The following describes a flow of a process performed when a user B operating the second operation apparatus 160 obtains the operational UI for operating the display data displayed on the first display apparatus 130.

The basic flow is the same as the flow shown in FIG. 6 in Embodiment 1. In the present case, however, after obtaining the operational UI in S206, the proxy obtainment unit 102 notifies the coordinated-apparatus-information proxy obtainment unit 131 about the first operation apparatus 150 from which the operational UI is to be obtained. Then, the coordinated-apparatus-information proxy obtainment unit 131 obtains the coordinated-apparatus information held by the coordinated-apparatus-information holding unit 151 of the notified operation apparatus.

According to the aforementioned process performed when the display data is displayed by the first display apparatus 130 and the second display apparatus 140, the coordinated-apparatus information held by the first operation apparatus 150 that is to be obtained here includes the information indicating the first display apparatus 130 and the information indicating the second display apparatus 140.

Next, the first display apparatus 130 transmits the operational UI to the second operation apparatus 160 in S208. Then, when notified by the proxy obtainment unit 102 about the apparatus that is the transmission destination of the operational UI, the first display apparatus 130 stores the coordinated-apparatus information obtained in S206 into the coordinated-apparatus-information holding unit 161 of the notified second operation apparatus 160.

As a result, when the user B operates the display data via the operational UI displayed on the second operation apparatus 160 after the completion of the processes up to S210, the display unit 121 of the second operation apparatus 160 transmits the corresponding instruction to both the first display apparatus 130 and the second display apparatus 140 indicated by the information held by the coordinated-apparatus-information holding unit 161. With this, the display data displayed by the two display apparatuses can be updated at the same time and, thus, an operation that is the same as the operation performed by the first operation apparatus 150 can be implemented.

Lastly, the following describes a flow of a process performed when the user A operating the first operation apparatus 150 terminates display of the display data currently being displayed by the first display apparatus 130 and the second display apparatus 140.

Since the process is basically the same as the process shown in FIG. 7 in Embodiment 1, the details are not repeated here. However, when the user instructs to terminate display in S302, the process from S304 to S306 is performed on the first display apparatus 130 and the second display apparatus 140 that are coordinated apparatuses. As a result, the transmitted operational UI is deleted from the different operation apparatuses.

The following describes a flow of a series of processes performed by the first display apparatus 130, the second display apparatus 140, the first operation apparatus 150 and the second operation apparatus 160.

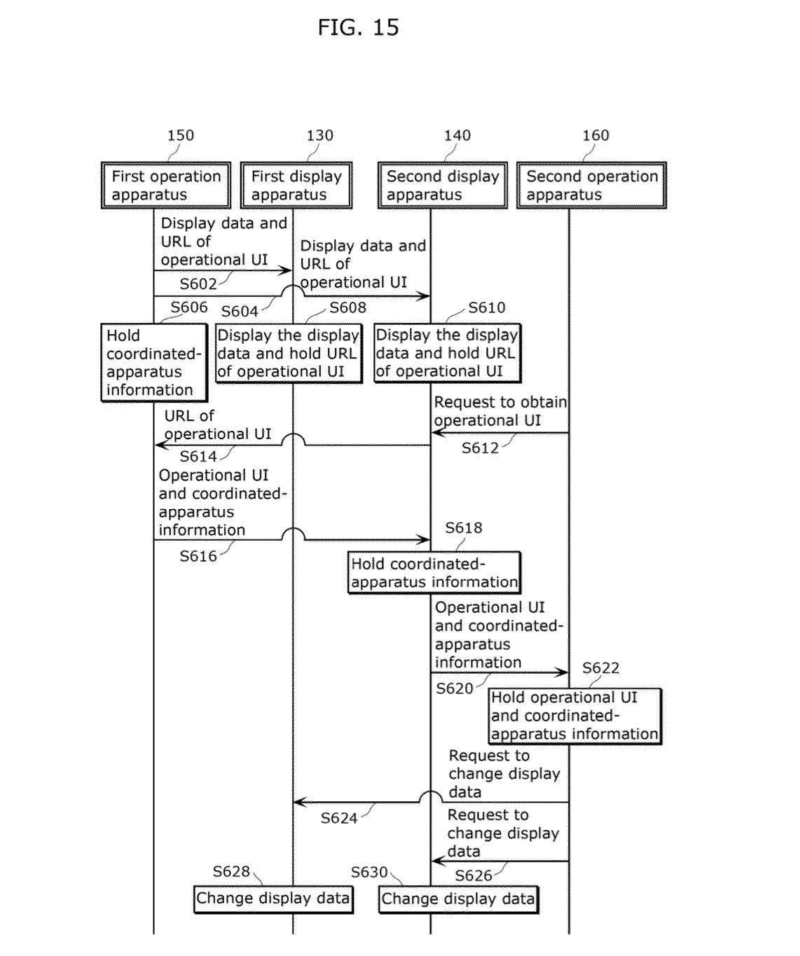

FIG. 15 is a sequence diagram showing processes performed by the first display apparatus 130, the second display apparatus 140, the first operation apparatus 150, and the second operation apparatus 160, in Embodiment 1 according to the present invention.

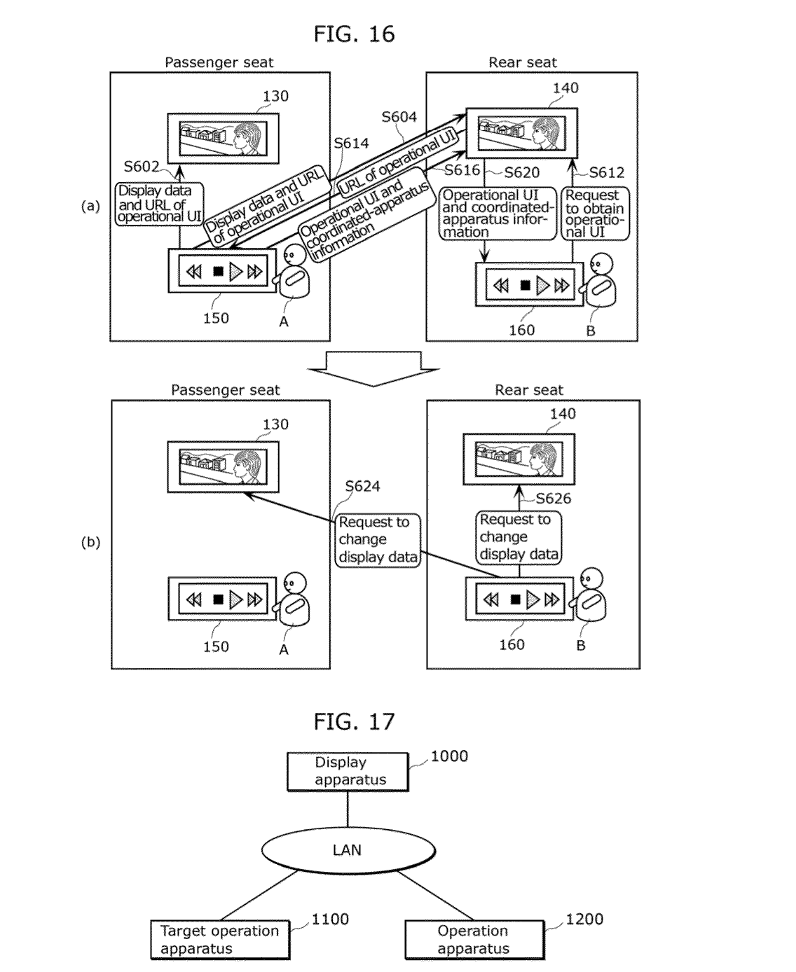

FIG. 16 is a diagram explaining the processes performed by the first display apparatus 130, the second display apparatus 140, the first operation apparatus 150, and the second operation apparatus 160, in Embodiment 1 according to the present invention.

In FIG. 16, the first display apparatus 130 is shown as being provided for a passenger seat of a car, and the second display apparatus 140 is shown as being provided for a rear seat of the car. Moreover, the first operation apparatus 150 is shown as, for example, a smartphone provided for the passenger seat of the car, and the second operation apparatus 160 is shown as, for example, a smartphone provided for the rear seat of the car. The first operation apparatus 150 is operated by the user A and the second operation apparatus 120 is operated by the user B.

As shown in FIG. 15 and (a) of FIG. 16, by an operation of the user A, the first operation apparatus 150 firstly transmits, to the first display apparatus 130, the display data and the URL of the operational UI that is the identifier for identifying the operational information held by the data holding unit 114 (S602). Moreover, the first operation apparatus 150 also transmits the present display data and the present URL of the operational UI to the second display apparatus 140 (S604). Thus, each of the first display apparatus 130 and the second display apparatus 140 receives the display data and the URL of the operational UI transmitted from the first operation apparatus 150.

Next, the coordinated-apparatus-information holding unit 151 of the first operation apparatus 150 holds, as the coordinated-apparatus information, the first display apparatus information and the second display apparatus information respectively indicating the first display apparatus 130 and the second display apparatus 140 to both of which the display data and the URL of the operational UI were transmitted (S606).

Then, the first display apparatus 130 displays the received display data on the display unit 101 and allows the proxy obtainment unit 102 to hold the received URL of the operational UI (S608). Similarly, the second display apparatus 140 displays the received display data on the display unit 141 and allows the proxy obtainment unit 142 to hold the received URL of the operational UI (S608).

Next, according to the instruction from the user B, the second operation apparatus 160 requests the second display apparatus 140 to obtain the operational UI that is the operational information (S612). It should be noted that the second operation apparatus 160 may request the first display apparatus 130 to obtain the operational UI.

Receiving the request to obtain the operational UI, the second display apparatus 140 transmits, to the first operation apparatus 150, the URL of the operational UI received by the second display apparatus 140 from the first operation apparatus 150. Thus, the first operation apparatus 150 obtains the URL of the operational UI (S614).

Then, using the URL of the operational UI obtained from the second display apparatus 140, the first operation apparatus 150 obtains the operational UI indicated by the URL and thus transmits this operational UI and the coordinated-apparatus information (S616).

Thus, the second display apparatus 140 receives the operational UI and the coordinated-apparatus information transmitted from the first operation apparatus 150, and allows the coordinated-apparatus-information proxy obtainment unit 143 to hold the coordinated-apparatus information (S618).

Then, the second display apparatus 140 transmits the operational UI and the coordinated-apparatus information to the second operation apparatus 160, so that the second operation apparatus 160 obtains the operational UI and the coordinated-apparatus information transmitted from the first operation apparatus 150 (S620).

Following this, the second operation apparatus 160 allows the data holding unit 124 to hold the obtained operational UI, and allows the coordinated-apparatus-information holding unit 161 to hold the obtained coordinated-apparatus information (S622).

Then, as shown in FIG. 15 and (b) of FIG. 16, using the operational UI held by the data holding unit 124, the second operation apparatus 160 transmits, to the first display apparatus 130, the data for changing the display data displayed by the first display apparatus 130 (S624). Moreover, the second operation apparatus 160 also transmits, to the second display apparatus 140, the data for changing the display data displayed by the second display apparatus 140 (S626). To be more specific, the user B requests the second operation apparatus 160, via the operational UI, to change the display data displayed by the first display apparatus 130 and the second display apparatus 140.

As a result, the first display apparatus 130 changes the currently displayed data (S628) and, similarly, the second display apparatus 140 also changes the currently displayed data (S630).

As described thus far, with the second operation apparatus 160 in Embodiment 2 according to the present invention, the data obtainment unit 123 obtains the operational information, and the data transmission unit 125 transmits, to the first display apparatus 130 and the second display apparatus 140, the data for changing, using the operational information, the display data displayed by the first display apparatus 130 and the second display apparatus 140 indicated respectively by the first display apparatus information and the second display apparatus information held by the apparatus information holding unit 161. More specifically, since the data for changing the display data is transmitted to both the first display apparatus 130 and the second display apparatus 140 based on the operational information obtained by the second operation apparatus 160, the user can change, in a single step, the display data displayed by the first display apparatus 130 and the second display apparatus 140. In this way, the operation apparatus operated by the user can obtain the operational information regarding the plurality of display apparatuses. Hence, the user can easily operate the display data displayed by the display apparatuses without knowing which apparatus holds the display data and the operational information.

In Embodiment 2, when the user is to operate the display data of the first display apparatus 130 from the second operation apparatus 160, the user also operates the display data of the second display apparatus 140 as is the case with the first operation apparatus 150. However, note that, based on the information held by the coordinated-apparatus-information holding unit 161 of the second operation apparatus 160, the user may be informed that a plurality of display apparatuses are coordinated. Then, the user may select whether to operate the display apparatuses at the same time or operate only the display apparatus specified by the user.

In Embodiment 2, the coordinated-apparatus-information holding unit holds, as the coordinated-apparatus information, only the information indicating the display apparatus displaying the display data. However, note that, for the case where the same display data stored in the data holding units of the different operation apparatuses is displayed on the display apparatuses at the same time or in succession, the coordinated-apparatus-information holding unit may also hold information regarding the operation apparatuses holding the display data. As a result, the coordination states between the operation apparatuses holding the display data may be taken over so that the operation can be performed similarly from both the first operation apparatus 150 and the second operation apparatus 160.

Moreover, by additionally storing the information regarding the operation apparatus displaying the operational UI into the coordinated-apparatus-information holding unit, the coordination may be secured between the operation apparatuses and the states of the operational UIs displayed by the operation apparatuses, such as cursor positions and button selection states, may be synchronized.

Furthermore, when a target operation apparatus as in the conventional apparatus coordination control system is present, information regarding the target operation apparatus may be held by the coordinated-apparatus-information holding unit.

Moreover, when the display data is video and audio is to be outputted from an audio output apparatus different from the display apparatus, the coordinated-apparatus-information holding unit may hold information regarding the audio output apparatus so that the audio output apparatus can also be operated. Furthermore, when not only the display data but also different apparatuses such as an air conditioner and a lighting apparatus can be operated using the operational UI, the coordinated-apparatus-information holding unit may hold information regarding these different apparatuses so that coordinated operations performed with these different apparatuses can be taken over.

In Embodiment 2, the second operation apparatus 160 transmits, to the first display apparatus 130, the data for changing the display data currently displayed by the first display apparatus 130 and also transmits, to the second display apparatus 140, the data for changing the display data currently displayed by the second display apparatus 140. However, note that after the second operation apparatus 160 transmits, to the second display apparatus 140, the data for changing the display data currently displayed by the second display apparatus 140, the second display apparatus 140 may transmit, to the first display apparatus 130, the data for changing the display data currently displayed by the first display apparatus 130. To be more specific, the user B requests the second operation apparatus 160, via the operational UI, to change the display data currently displayed on the second display apparatus 140. As a result, each of the first display apparatus 130 and the second display apparatus 140 changes the corresponding currently displayed data. It should be noted that, using the held coordinated-apparatus information, the second display apparatus 140 can transmit the corresponding data to the first display apparatus 130 that is included in this coordinated-apparatus information.

Embodiments disclosed thus far only describe examples and are not intended to limit the scope of the present invention. It is to be noted that various changes and modifications will be apparent to those skilled in the art and that the features of the embodiments may be combined so long as they are not mutually contradictory. Therefore, embodiments implemented based on the changes, modifications, and combinations should be construed as being included in the present invention.

It should be noted that each of the components described in Embodiments above may be configured with dedicated hardware or may be implemented by executing a software program appropriately corresponding to the component. For example, each of the components may be implemented by a program execution unit, such as a CPU or a processor, that reads and executes the software program recorded on a hard disk or a recording medium such as a semiconductor memory.

To be more specific, each of the components in the display apparatus shown in FIG. 2, FIG. 13A, or FIG. 13B may be implemented by software. The software implementing the display apparatus described in each of Embodiments above is a computer program that causes a computer to execute steps included in a display method as follows. More specifically, this display method is a display method used by a display apparatus that is connected to a first operation apparatus and a second operation apparatus via a communication network and displays display data on a screen according to a request from the first operation apparatus, each of the first operation apparatus and the second operation apparatus operating the display data displayed on the screen and the display method including: receiving the display data transmitted from the first operation apparatus and displaying the received display data on the screen; and obtaining, from the first operation apparatus, an identifier that identifies operational information used for operating the display data displayed in the receiving and displaying, and allowing the second operation apparatus to obtain the operational information specified by the identifier when requested by the second operation apparatus to obtain the operational information.

Moreover, each of the components, except for the data holding unit, in the operation apparatus shown in FIG. 3A, FIG. 3B, FIG. 10A, FIG. 10B, FIG. 14A, or FIG. 14B may be implemented by software. The software implementing the operation apparatus described in each of Embodiments above is a computer program that causes a computer to execute steps included in an operation method as follows. More specifically, this operation method is an operation method used by an operation apparatus that is connected via a communication network to a display apparatus displaying display data on a screen and operates the display data displayed by the display apparatus, the operation method including: allowing the display apparatus to obtain the display data and transmitting, to the display apparatus, an identifier that is held by a data holding unit and identifies operational information used for operating the display data; obtaining the identifier received by the display apparatus, according to an obtainment request made to the display apparatus to obtain the operational information by a different operation apparatus operating the display data; and allowing the different operation apparatus to obtain the operational information by transmitting the operational information specified by the identifier, when the data obtainment unit obtains the identifier.

It should be noted that all the function blocks in the display apparatus shown in FIG. 2, FIG. 13A, or FIG. 13B and in the operation apparatus shown in FIG. 3A, FIG. 3B, FIG. 10A, FIG. 10B, FIG. 14A, or FIG. 14B may be implemented as an LSI which is an integrated circuit device. These may be integrated into individual chips or may be integrated into one chip including some or all of them.

For example, as shown in FIG. 10A, the units of the first operation apparatus 110a except for the data holding unit 114 may be implemented as an integrated circuit 110b. Moreover, as shown in FIG. 10B, the units of the second operation apparatus 120a except for the data holding unit 124 may be implemented as an integrated circuit 120b.

Although referred to as the LSI here, it may be referred to as an IC, a system LSI, a super LSI, or an ultra LSI depending on the scale of integration.

A method for circuit integration is not limited to application of an LSI. It may be implemented as a dedicated circuit or a general purpose processor. It is also possible to use a Field Programmable Gate Array (FPGA) that can be programmed after the LSI is manufactured, or a reconfigurable processor in which connection and setting of circuit cells inside the LSI can be reconfigured.

Moreover, when a circuit integration technology that replaces LSIs comes along owing to advances of the semiconductor technology or to a separate derivative technology, the function blocks should be understandably integrated using that technology. There can be a possibility of adaptation of biotechnology, for example.

Moreover, among the components of the user interaction apparatus, only the unit that stores the data may be configured separately instead of being integrated into one chip.

It should be noted that the present invention can be implemented not only as a display apparatus, an operation apparatus, or an apparatus coordination control system, but also as: a display method, an operation method, or an apparatus coordination control method having, as steps, the corresponding characteristic processes of the display apparatus, the operation apparatus, or the apparatus coordination control system. Moreover, the present invention can be implemented as a computer program causing a computer to execute the steps included in these methods. It should be obvious that the present invention can be distributed via a computer-readable recording medium, such as a Compact Disc-Read Only Memory (CD-ROM), having the computer program recorded thereon or via a transmission medium such as the Internet.

### INDUSTRIAL APPLICABILITY

The display apparatus, the operation apparatus, or the apparatus coordination control system according to the present invention is useful as an apparatus or a system for coordinating a plurality of apparatuses, displaying contents including video, photographs, text, and Web pages on a different apparatus, and operating the displayed data. Moreover, when the display data is a different kind of data, such as music data, the present invention can be applied to an apparatus coordination control system or the like that allows a different apparatus to reproduce music.

### REFERENCE SIGNS LIST

10, 11 Apparatus coordination control system
100 Display apparatus
101, 141 Display unit
102, 142 Proxy obtainment unit
110, 110a, 150 First operation apparatus
110b, 120b Integrated circuit
111, 121 Display unit
112, 122 Operation receiving unit
113, 123 Data obtainment unit
114, 124 Data holding unit
115, 125 Data transmission unit
120, 120a, 160 Second operation apparatus
130 First display apparatus
131, 143 Coordinated-apparatus-information proxy obtainment unit
140 Second display apparatus
151, 161 Coordinated-apparatus-information holding unit
1000 Display apparatus
1201 Display unit
1100 Target operation apparatus
1101 Data holding unit
1102 Data transmission unit
1200 Operation apparatus
1201 Display unit
1202 Operation receiving unit
1203 Data obtainment unit

1. A display apparatus that is connected to a first operation apparatus and a second operation apparatus via a communication network and displays display data on a screen according to a request from the first operation apparatus, each of the first operation apparatus and the second operation apparatus operating the display data displayed on the screen and the display apparatus comprising:
a display unit configured to receive the display data transmitted from the first operation apparatus and display the received display data on the screen; and
a proxy obtainment unit configured to obtain, from the first operation apparatus, an identifier that identifies operational information used for operating the display data displayed by the display unit, and to allow the second operation apparatus to obtain the operational information specified by the identifier when requested by the second operation apparatus to obtain the operational information.

2. The display apparatus according to claim 1,
wherein the proxy obtainment unit is configured to
(i) obtain, as the identifier, storage location information regarding a storage location of the operational information held by the first operation apparatus,
(ii) obtain the operational information from the storage location indicated by the storage location information, when requested by the second operation apparatus to obtain the operational information, and
(iii) allow the second operation apparatus to obtain the operational information by transmitting the obtained operational information to the second operation apparatus.

3. The display apparatus according to claim 1,
wherein the proxy obtainment unit is configured to
(i) obtain, as the identifier, storage location information regarding a storage location of the operational information held by the first operation apparatus, and
(ii) allow the second operation apparatus to obtain the operational information by transmitting the storage location information to the second operation apparatus, when requested by the second operation apparatus to obtain the operational information.

4. The display apparatus according to claim 1,
wherein, when receiving a request from the first operation apparatus to terminate display of the display data, the proxy obtainment unit is configured to cause the second operation apparatus to delete the operational information obtained by the second operation apparatus.

5. An operation apparatus that is connected via a communication network to a display apparatus displaying display data on a screen and operates the display data displayed by the display apparatus, the operation apparatus comprising:
a data holding unit configured to hold an identifier that identifies operational information used for operating the display data;
a data transmission unit configured to transmit the identifier held by the data holding unit to the display apparatus and allow the display apparatus to obtain the display data and; and
a data obtainment unit configured to obtain the identifier received by the display apparatus, according to an obtainment request made to the display apparatus to obtain the operational information by a different operation apparatus operating the display data,
wherein, when the data obtainment unit obtains the identifier, the data transmission unit is configured to transmit the operational information specified by the identifier to allow the different operation apparatus to obtain the operational information.

6. The operation apparatus according to claim 5,
wherein the data holding unit is configured to hold, as the identifier, storage location information regarding a storage location of the operational information, in association with the display data and the operational information,
the data transmission unit is configured to transmit, to the display apparatus, the display data and the storage location information both held by the data holding unit,
the data obtainment unit is configured to obtain, from the display apparatus, the storage location information received by the display apparatus, according to the obtainment request, and
the data transmission unit is configured to transmit, to the display apparatus, the operational information associated with the storage location information held by the data holding unit to allow the different operation apparatus to obtain the operational information via the display apparatus, when the data obtainment unit obtains the storage location information from the display apparatus.

7. The operation apparatus according to claim 5,
wherein the data holding unit is configured to hold, as the identifier, storage location information regarding a storage location of the operational information, in association with the display data and the operational information,
the data transmission unit is configured to transmit, to the display apparatus, the display data and the storage location information both held by the data holding unit,
the data obtainment unit is configured to obtain, from the different operation apparatus, the storage location information that the display apparatus has received and transmitted to the different operation apparatus, according to the obtainment request, and
the data transmission unit is configured to transmit, to the different operation apparatus, the operational information associated with the storage location information held by the data holding unit to allow the different operation apparatus to obtain the operational information, when the data obtainment unit obtains the storage location information from the different operation apparatus.

8. The operation apparatus according to claim 5,
wherein the data obtainment unit is further configured to receive a termination request to terminate display of the display data displayed by the display apparatus, and
when the data obtainment unit receives the termination request, the data transmission unit is configured to transmit the termination request to terminate display of the display data to the display apparatus and cause the different operation apparatus to delete the operational information obtained by the different operation apparatus.

9. The operation apparatus according to claim 8,
wherein, when the data obtainment unit receives the termination request, the data transmission unit is further configured to cause the display apparatus to delete the identifier held by the display apparatus.

10. The operation apparatus according to claim 5,
wherein the data holding unit is configured to hold, as the identifier, an identifier that identifies operational information where a predetermined operation is not permitted, and
the data transmission unit is configured to allow the different operation apparatus to obtain the operational information, specified by the identifier, where the predetermined operation is not permitted.

11. The operation apparatus according to claim 5,
wherein the data obtainment unit is further configured to obtain (i) the operational information used for operating the display data that the different operation apparatus causes the first display apparatus or the second display apparatus to display, according to an obtainment request, and (ii) first display apparatus information indicating the first display apparatus and second display apparatus information indicating the second display apparatus from the different operation apparatus that causes the display data to be displayed, via the first display apparatus or the second display apparatus,
the data holding unit is further configured to hold the obtained operational information,
the operation apparatus further comprises
a coordinated-apparatus-information holding unit configured to hold the obtained first display apparatus information and the obtained second display apparatus information, and
the data transmission unit is further configured to transmit, to the first display apparatus and the second display apparatus, data for changing, using the operational information held by the data holding unit, the display data displayed by the first display apparatus and the second display apparatus indicated respectively by the first display apparatus information and the second display apparatus information held by the coordinated-apparatus-information holding unit.

12. An apparatus coordination control system comprising
a first operation apparatus, a second operation apparatus, and a display apparatus that are connected via a communication network, each of the first operation apparatus and the second operation apparatus operating display data displayed on a screen and the display apparatus displaying the display data on the screen according to a request from the first operation apparatus,
wherein the first operation apparatus includes:
a data holding unit configured to hold an identifier that identifies operational information used for operating the display data;
a data transmission unit configured to transmit the identifier held by the data holding unit to the display apparatus and allow the display apparatus to obtain the display data; and
a data obtainment unit configured to obtain the identifier received by the display apparatus, according to an obtainment request made to the display apparatus to obtain the operational information by the second operation apparatus,
the data transmission unit being further configured to transmit the operational information specified by the identifier to allow the second operation apparatus to obtain the operational information, when the data obtainment unit obtains the identifier,
the display apparatus includes:
a display unit configured to receive the display data transmitted from the first operation apparatus and display the received display data on the screen; and
a proxy obtainment unit configured to obtain, from the first operation apparatus, the identifier that identifies the operational information used for operating the display data displayed by the display unit, and to allow the second operation apparatus to obtain the operational information specified by the identifier when requested by the second operation apparatus to obtain the operational information, and
the second operation apparatus includes:
a data obtainment unit configured to obtain the operational information according to the obtainment request made to the display apparatus to obtain the operational information;
a data holding unit configured to hold the obtained operational information; and
a data transmission unit configured to transmit, to the display apparatus, data for changing the display data displayed by the display apparatus using the operational information held by the data holding unit.

13. A display method used by a display apparatus that is connected to a first operation apparatus and a second operation apparatus via a communication network and displays display data on a screen according to a request from the first operation apparatus, each of the first operation apparatus and the second operation apparatus operating the display data displayed on the screen and the display method comprising:
receiving the display data transmitted from the first operation apparatus and displaying the received display data on the screen; and
obtaining, from the first operation apparatus, an identifier that identifies operational information used for operating the display data displayed in the receiving and displaying, and allowing the second operation apparatus to obtain the operational information specified by the identifier when requested by the second operation apparatus to obtain the operational information.

14. An operation method used by an operation apparatus that is connected via a communication network to a display apparatus displaying display data on a screen and operates the display data displayed by the display apparatus, the operation method comprising:
allowing the display apparatus to obtain the display data and transmitting, to the display apparatus, an identifier that is held by a data holding unit and identifies operational information used for operating the display data;
obtaining the identifier received by the display apparatus, according to an obtainment request made to the display apparatus to obtain the operational information by a different operation apparatus operating the display data; and
allowing the different operation apparatus to obtain the operational information by transmitting the operational information specified by the identifier, when the identifier is obtained in the obtaining.

15. An apparatus coordination control method performed by a first operation apparatus, a second operation apparatus, and a display apparatus that are connected via a communication network, each of the first operation apparatus and the second operation apparatus operating display data displayed on a screen, the display apparatus displaying the display data on the screen according to a request from the first operation apparatus, and the apparatus coordination control method comprising:
transmitting the display data and an identifier that is held by a data holding unit and identifies operational information used for operating the display data, to the display apparatus from the first operation apparatus;
receiving the display data and the identifier, by the display apparatus from the first operation apparatus;
causing the screen to display the received display data, by the display apparatus;
requesting the operational information, to the display apparatus by the second operation apparatus;
obtaining the identifier received by the display apparatus, by the first operation apparatus according to a request made in the requesting;
transmitting the operational information specified by the obtained identifier, from the first operation apparatus;
obtaining the operational information transmitted from the first operation apparatus, by the second operation apparatus;
causing the data holding unit to hold the obtained operational information, by the second operation apparatus; and
transmitting data for changing the display data displayed by the display apparatus using the operational information held by the data holding unit, to the display apparatus from the second operation apparatus.

16. A non-transitory computer-readable recording medium for use in a computer, the recording medium having a computer program recoded thereon for causing a display apparatus connected to a first operation apparatus and a second operation apparatus via a communication network to display display data on a screen according to a request from the first operation apparatus, each of the first operation apparatus and the second operation apparatus operating the display data displayed on the screen, and the computer program causing the computer to execute:
receiving the display data transmitted from the first operation apparatus and displaying the received display data on the screen; and
obtaining, from the first operation apparatus, an identifier that identifies operational information used for operating the display data displayed in the receiving and displaying, and allowing the second operation apparatus to obtain the operational information specified by the identifier when requested by the second operation apparatus to obtain the operational information.

17. A non-transitory computer-readable recording medium for use in a computer, the recording medium having a computer program recorded thereon for causing an operation apparatus to operate display data displayed on a screen, the operation apparatus being connected via a communication network to a display apparatus displaying the display data on the screen and the computer program causing the computer to execute:
allowing the display apparatus to obtain the display data and transmitting, to the display apparatus, an identifier that is held by a data holding unit and identifies operational information used for operating the display data;
obtaining the identifier received by the display apparatus, according to an obtainment request made to the display apparatus to obtain the operational information by a different operation apparatus operating the display data; and
allowing the different operation apparatus to obtain the operational information by transmitting the operational information specified by the identifier, when the identifier is obtained in the obtaining.

18. An integrated circuit that is connected to a first operation apparatus and a second operation apparatus via a communication network and displays display data on a screen according to a request from the first operation apparatus, each of the first operation apparatus and the second operation apparatus operating the display data displayed on the screen and the integrated circuit comprising:
a display unit configured to receive the display data transmitted from the first operation apparatus and display the received display data on the screen; and
a proxy obtainment unit configured to obtain, from the first operation apparatus, an identifier that identifies operational information used for operating the display data displayed by the display unit, and to allow the second operation apparatus to obtain the operational information specified by the identifier when requested by the second operation apparatus to obtain the operational information.

19. An integrated circuit that is connected via a communication network to a display apparatus displaying display data on a screen and operates the display data displayed by the display apparatus, the integrated circuit comprising:
a data transmission unit configured to transmit, to the display apparatus, an identifier that is held by a data holding unit and identifies operational information used for operating the display data, and to allow the display apparatus to obtain the display data; and
a data obtainment unit configured to obtain the identifier received by the display apparatus, according to an obtainment request made to the display apparatus to obtain the operational information by an operation apparatus operating the display data,
wherein, when the data obtainment unit obtains the identifier, the data transmission unit is configured to transmit the operational information specified by the identifier to allow the operation apparatus to obtain the operational information.
